(19) United States
(12) Patent Application Publication
(10) Pub. No.: US 2025/0374275 A1
(43) Pub. Date: Dec. 4, 2025

(54) ENHANCED SCHEDULING OF DATA RADIO BEARER

(71) Applicant: Dell Products L.P., Round Rock, TX (US)

(72) Inventor: Hemant Kumar Bhawarlal Jain, Bangalore (IN)

(21) Appl. No.: 18/677,628

(22) Filed: May 29, 2024

(51) Int. Cl. H04W 72/1273; H04W 72/542; H04W 72/566

(52) U.S. Cl. CPC H04W 72/1273; H04W 72/542; H04W 72/566

(57) ABSTRACT

Scheduling of downlink communication of data associated with DRBs can be managed and enhanced. Communication manager component (CMC) can determine respective DRB delay metrics associated with respective DRBs associated with a device based on respective priority levels and respective packet delay metrics associated with respective downlink data packets associated with the respective DRBs. CMC can determine respective smallest packet delay metrics associated with respective priority levels and respective DRBs based on respective remaining packet delay budgets of respective downlink data packets. CMC can apply respective weight values associated with the respective priority levels to the respective smallest packet delay metrics. For each DRB, CMC can determine the DRB delay metric of the DRB based on the smallest weighted packet delay metric associated with the DRB. CMC can prioritize communication of downlink data packets associated with DRB determined to have smallest DRB delay metric over other DRBs.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise determining, by a system comprising at least one processor, respective data-radio-bearer delay metrics associated with respective data radio bearers associated with a device as a function of respective priority levels and respective packet delay metrics, wherein the respective priority levels can be associated with respective downlink data packets associated with the respective data radio bearers, and wherein the respective packet delay metrics can be associated with the respective downlink data packets and the respective priority levels. The method also can comprise determining, by the system, a scheduling of communication of the respective downlink data packets associated with the respective data radio bearers to the device based on the respective data-radio-bearer delay metrics.

In certain embodiments, the disclosed subject matter can comprise a system that can comprise at least one memory that can store computer executable components, and at least one processor that can execute computer executable components stored in the at least one memory. The computer executable components can comprise a communication manager that can determine respective data-radio-bearer delay values associated with respective data radio bearers associated with a user equipment based on respective importance values and respective packet delay values, wherein the respective importance values can be associated with respective downlink data packets associated with the respective data radio bearers, and wherein the respective packet delay values can be associated with the respective downlink data packets and the respective importance values. The computer executable components also can comprise a scheduler that can determine a scheduling of communication of the respective downlink data packets associated with the respective data radio bearers to the user equipment based on the respective data-radio-bearer delay values.

In still other embodiments, the disclosed subject matter can comprise a non-transitory machine-readable medium, comprising executable instructions that, when executed by at least one processor, can facilitate performance of operations. The operations can comprise determining respective data-radio-bearer delay values associated with respective data radio bearers associated with a user equipment based on respective priority levels and respective packet delay values, wherein the respective priority levels can be associated with respective downlink data packets associated with the respective data radio bearers, and wherein the respective packet delay values can be associated with the respective downlink data packets and the respective priority levels. The operations also can comprise scheduling transmission of the respective downlink data packets associated with the respective data radio bearers to the user equipment based on the respective data-radio-bearer delay values.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably enhance management of scheduling and communication of downlink data, such as downlink data packets, in accordance with various aspects and embodiments of the disclosed subject matter.

FIG. 2 depicts a block diagram of non-limiting example communication manager component that can enhance management of scheduling and communication of downlink data, such as downlink data packets, for a radio access network (RAN), in accordance with various aspects and embodiments of the disclosed subject matter.

FIG. 3 illustrates a block diagram of non-limiting example data radio bearers (DRBs) associated with a device in connection with utilization of a service, in accordance with various aspects and embodiments of the disclosed subject matter.

FIG. 4 illustrates a block diagram of non-limiting example system that can comprise the RAN, which can comprise the communication manager component that can desirably enhance management of scheduling and communication of downlink data, in accordance with various aspects and embodiments of the disclosed subject matter.

FIG. 5 depicts a diagram of a non-limiting example base station that can desirably facilitate connections and communication of information associated with devices, in accordance with various aspects and embodiments of the disclosed subject matter.

FIG. 6 illustrates a diagram of a non-limiting example device that can be operable to engage in a system architecture that facilitates wireless communications according to one or more embodiments described herein, in accordance with various aspects and embodiments of the disclosed subject matter.

FIG. 7 illustrates a flow chart of an example method that can desirably enhance management of scheduling and communication of downlink data, in accordance with various aspects and embodiments of the disclosed subject matter.

FIGS. 8 and 9 depict a flow chart of another example method that can desirably enhance management of scheduling and communication of downlink data, in accordance with various aspects and embodiments of the disclosed subject matter.

FIG. 10 illustrates an example block diagram of an example computing environment in which the various embodiments of the embodiments described herein can be implemented.

FIG. 11 illustrates a diagram of an example communication session that can comprise data bursts comprising protocol data unit (PDU) sets in connection with the use of a service by a device.

FIG. 12 depicts a diagram of example PDU sets of a data burst, wherein the PDU sets can be associated with a PDU set delay budget and PDU set importance (PSI) values.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to enhanced management and scheduling of data radio bearers (DRBs) when devices are utilizing services, such as, for example, extended reality (XR) services or other type of service that can involve communication of one or more respective data bursts comprising respective protocol data unit (PDU) sets. A device, such as a mobile device (e.g., user equipment (UE), smart phone, or other mobile wireless device) can connect (e.g., wirelessly connect) to a cell (e.g., cell of a base station) or other access point associated with the RAN of the communication network to facilitate connection to the communication network.

Certain applications and services, such as XR applications and services, can generate periodic data bursts, where each data burst can comprise one or more PDU sets. Each PDU set can comprise one or more PDUs, wherein each PDU can comprise (e.g., can carry) a data payload of one unit of information generated at the application level (e.g., a frame or video slice). A PDU set can be the smallest granularity from the point of view of the XR application. Each PDU set can be associated with a PDU set importance (PSI) value (e.g., PSI indicator or flag having a certain value), which can provide the relative importance or priority of the PDU set when compared to other PDU sets within the quality of service (QoS) flow. The PSI values can have range, for example, from 0 to 15, wherein PSI 0 can indicate that a PDU set has a highest importance or priority, and PSI 15 can indicate that a PDU set has a lowest importance or priority. For each PDU set, the PSI value can be the same for all of the PDUs of that PDU set.

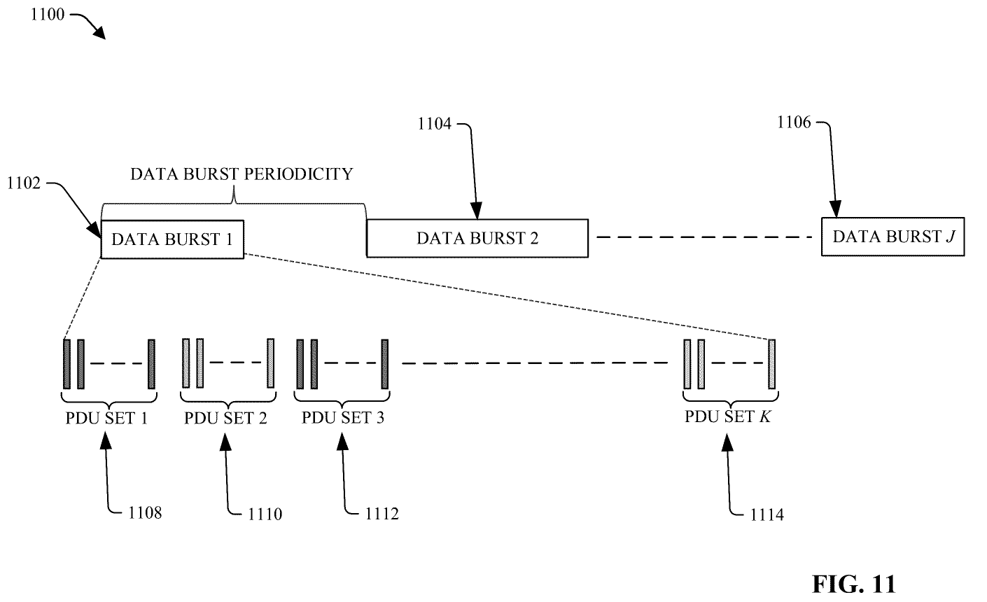

Referring briefly to FIG. 11, FIG. 11 illustrates a diagram of an example communication session 1100 that can comprise data bursts (e.g., periodic data bursts) comprising PDU sets in connection with the use of a service by a device. The communication session 1100 can comprise data bursts, such as data burst 1102 (e.g., data burst 1), data burst 1104 (e.g., data burst 2), and data burst 1106 (e.g., up through data burst J, wherein J can be a numerical value), that can be generated by the service (e.g., a service device of the service), and communicated (e.g., periodically communicated) to the device via the RAN, in accordance with a data burst periodicity. The respective data bursts (e.g., 1102, 1104, and 1106) can comprise one or more respective PDU sets (e.g., downlink PDU sets) that each can comprise one or more PDUs. For instance, with regard to the data burst 1102, the data burst 1102 can comprise a first PDU set 1108 (e.g., PDU set 1), a second PDU set 1110 (e.g., PDU set 2), a third PDU set 1112 (e.g., PDU set 3), and/or another PDU set 1114 (e.g., PDU set K, wherein K can be a numerical value).

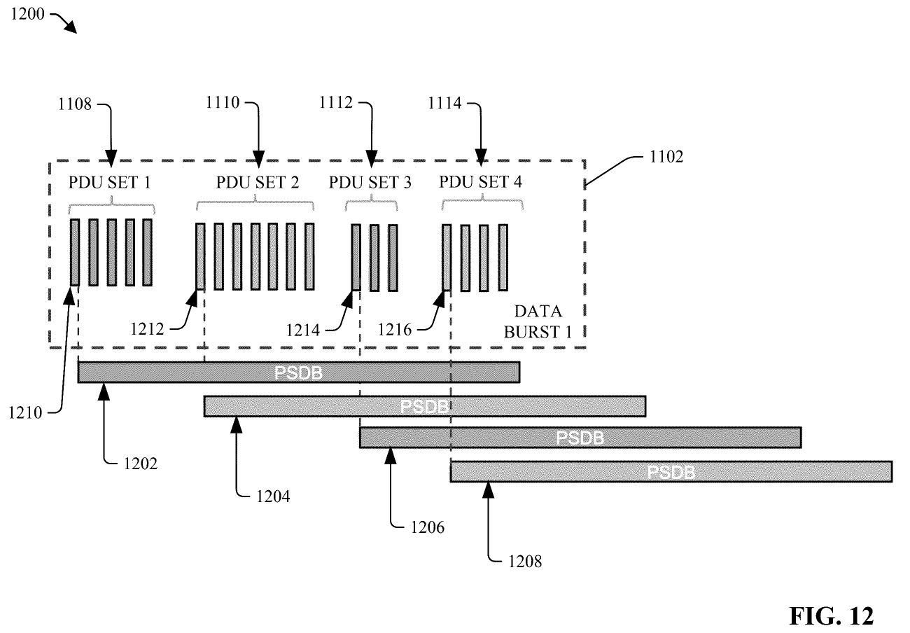

Turning briefly to FIG. 12 (along with FIG. 11), FIG. 12 depicts a diagram of example PDU sets 1200 of the data burst 1102, wherein the PDU sets 1200 can be associated with a PDU set delay budget (PSDB) and PDU set importance (PSI) values. The example PDU sets 1200 can comprise the first PDU set 1108, the second PDU set 1110, the third PDU set 1112, and/or the PDU set 1114, wherein, in the example PDU sets 1200, the PDU set 1114 can be a fourth PDU set that can follow the third PDU set 1112 in the data burst 1102. With regard to the PSDB, an access and mobility management function (AMF) node of the core network can provide the PSDB to the RAN during the PDU session setup.

With regard to PSI values, the respective PDU sets (e.g., 1108, 1110, 1112, and 1114) can have respective PSI values. For example, the first PDU set 1108 can have a first PSI value (e.g., PSI 5 or other applicable PSI value), the second PDU set 1110 can have a second PSI value (e.g., PSI 10 or other applicable PSI value), the third PDU set 1112 can have a third PSI value (e.g., PSI 5 or other applicable PSI value), and the fourth PDU set 1114 can have a fourth PSI value (e.g., PSI 10 or other applicable PSI value). Note that there can be multiple PDU sets in a data burst that can have the same PSI. As the RAN receives each PDU set (e.g., 1108, 1110, 1112, and 1114) of the data burst 1102, the RAN can start a timer to start the PSDB (e.g., 1202, 1204, 1206, and 1208, respectively) applicable for the PDU set (e.g., 1108, 1110, 1112, and 1114, respectively) upon reception of the first PDU (e.g., 1210, 1212, 1214, and 1216, respectively) of the PDU set (e.g., 1108, 1110, 1112, and 1114, respectively) from the user plane function (UPF) of the core network. It can be desirable to communicate the PDU set to the device before the PSDB expires.

XR services generally can be classified as a guaranteed bit rate (GBR) delay critical service which can have certain guaranteed throughput specifications (e.g., requirements) and certain packet delay budget specifications. A RAN scheduler typically can consider both the GBR and the packet delay budget specifications for determining (e.g., calculating) the scheduling metric for determining scheduling of communication of data packets associated with the service to the device. For the GBR metric, the RAN typically can use the percentage of GBR achieved.

With some existing techniques for scheduling of DRBs and associated downlink data packets, for the packet delay metric, the RAN can use the remaining packet delay budget of the oldest downlink data packet available at the RAN for communication to the device at the time of determining the scheduling. For example, consider two DRBs (with the assumption that the GBR metric is the same for both DRBs), the first DRB having four PDU sets (e.g., PDU set 1, PDU set 2, PDU set 3, and PDU set 4) available for scheduling at the RAN, and the second DRB having three PDU sets (e.g., PDU set A, PDU set B, and PDU set C) available for scheduling at the RAN. For DRB 1, PDU set 1 can be the oldest PDU set and PDU set 4 can be the newest PDU set available for scheduling at the RAN. For DRB 2, PDU set A can be the oldest PDU set and PDU set C can be the newest PDU set available for scheduling at the RAN.

With some existing techniques, the RAN can calculate the packet delay metric associated with DRB 1 as packet delay metric for DRB 1=packet delay budget−(current time−time when PDU set 1 was received from the UPF), and can calculate the packet delay metric associated with DRB 2 as packet delay metric for DRB 2=packet delay budget−(current time−time when PDU set A was received from UPF). In this regard, it is noted that, for XR data traffic, the packet delay budget can be equal to the PDU set delay budget. With some existing techniques, if PDU set 1 was received by the RAN before PDU set A, the RAN can determine that the DRB 1 has a higher priority than DRB 2 for scheduling of communication of the PDU sets to the device.

With further regard to this example, assume that, with regard to DRB 1, PDU set 1 and PDU set 4 have PSI 15 (e.g., the lowest priority or importance level), and PDU set 2 and PDU set 3 have PSI 10, and, with regard to DRB 2, PDU set A, PDU set B, and PDU set C each have PSI 0 (e.g., the highest priority or importance level). With some existing techniques, if PDU set 1 was received by the RAN before PDU set A (e.g., if PDU set 1 is the oldest downlink data packet overall of the available downlink data packets associated with the device at the RAN), the RAN can determine that the DRB 1 has a higher priority than DRB 2 for scheduling of communication of the PDU sets to the device, even though PDU set A associated with DRB 2 has a higher (e.g., significantly higher) priority or importance than PDU set 1 associated with DRB 1. This can mean that, with some existing techniques, lower priority downlink data packets undesirably (e.g., unwantedly, unsuitably, inefficiently, or suboptimally) can be prioritized over higher priority downlink data packets.

Thus, some existing techniques for scheduling of DRBs and associated downlink data packets can be deficient and undesirable in a number of ways, including that such existing techniques can fail to consider PSI values associated with downlink data packets (e.g., downlink PDU sets) when determining prioritizing and scheduling of DRBs and associated downlink data packets, and can suffer from undesirable oldest data packet bias, as the packet delay metric calculated using such existing techniques can rely on the oldest downlink data packet available at the RAN, which undesirably can potentially lead to a lower priority downlink data packet taking precedence over a higher priority downlink data packet with regard to scheduling of communication of downlink data packets to the device.

The disclosed subject matter can address and overcome the aforementioned deficiencies and other deficiencies of such existing techniques with regard to prioritizing and scheduling DRBs and associated downlink data packets. In that regard, it can be desirable (e.g., wanted, useful, efficient, advantageous, or optimal) to enhance the prioritization and management of scheduling of DRBs and associated downlink data packets for communication to a device, take respective priority levels associated with respective downlink data packets into account when determining the prioritization and scheduling of the DRBs and associated downlink data packets, have a flexible delay metric such that delay metric determinations can take into account respective priority levels associated with respective downlink data packets, rather than only taking into account which downlink data packet is the oldest available data packet at the RAN, and have a flexible weighting for PSI values (e.g., priority levels) such that delay metric determinations can be refined by adapting a PSI-to-PSI weight table that can offer desirable flexibility in adjusting weight values applied to PSI levels based at least in part on real time considerations.

The disclosed subject matter can employ enhanced management, prioritization, and scheduling techniques for managing, prioritizing, and scheduling DRBs and associated downlink data packets (e.g., PDU sets) for communication of the downlink data packets to devices that are using services (e.g., an XR service or other type of service). The disclosed subject matter, by employing such enhanced management, prioritization, and scheduling techniques, desirably (e.g., wantedly, usefully, efficiently, advantageously, enhancedly, or optimally) can enhance the prioritization and management of scheduling of DRBs and associated downlink data packets for communication to a device, can take respective priority levels associated with respective downlink data packets into account when determining the prioritization and scheduling of the DRBs and associated downlink data packets, can have a flexible delay metric such that delay metric determinations can take into account respective priority levels associated with respective downlink data packets, rather than only taking into account which downlink data packet is the oldest available data packet at the RAN, and can have a flexible weighting for PSI values (e.g., priority levels) such that delay metric determinations can be refined by adapting a PSI-to-PSI weight table that can offer desirable flexibility in adjusting weight values applied to PSI levels based at least in part on real time considerations.

To that end, techniques that can desirably (e.g., automatically, dynamically, suitably, reliably, efficiently, enhancedly, and/or optimally) enhance management of scheduling and communication of downlink data, such as data packets of PDU sets, are presented. A system can comprise a RAN that can communicate data to a device via a group of DRBs. In some embodiments, the device can be utilizing one or more services, which can include, for example, an XR service or other service that can involve communication of one or more respective data bursts comprising respective PDU sets. The RAN can comprise a communication manager component that can desirably enhance and manage scheduling and communication of downlink data, such as data packets of PDU sets, to the device, in accordance with defined communication management criteria.

The communication manager component can determine respective DRB delay metrics associated with respective DRBs associated with the device based at least in part on respective packet delay metrics associated with the respective downlink data packets, which can be associated with the respective priority levels (e.g., respective PSIs) and associated with the respective DRBs. The communication manager component can determine the respective downlink data packets that are available at the RAN (e.g., at RAN equipment of the RAN) for communication to the device via the respective DRBs. The communication manager component can determine the respective packet delay metrics associated with the respective downlink data packets with regard to the respective priority levels and the respective DRBs based at least in part on the packet delay budget, the current time, and the respective times when the respective downlink data packets were received by the RAN from the UPF.

The communication manager component can determine respective smallest packet delay metrics associated with the respective priority levels and the respective DRBs based at least in part on the results of analyzing the respective packet delay metrics for each priority level for each DRB. The communication manager component can apply respective weight values associated with the respective priority levels to the respective smallest packet delay metrics to determine or generate respective weighted smallest packet delay metrics associated with the respective priority levels, with regard to the respective DRBs. For each DRB, the communication manager component can determine the DRB delay metric of the DRB based at least in part on the smallest weighted packet delay metric associated with the DRB (e.g., the DRB delay metric can be the minimum of the respective smallest weighted packet delay metrics associated with the respective levels associated with the DRB). Based at least in part on the results of analyzing (e.g., comparing) the respective DRB delay metrics associated with the respective DRBs, the communication manager component can determine the DRB delay metric that is the smallest of the respective DRB delay metrics. The communication manager component can prioritize communication, to the device, of downlink data packets associated with the DRB determined to have smallest DRB delay metric over communication, to the device, of other downlink data packets associated with the one or more other DRBs associated with the device.

The disclosed subject matter, by employing the communication manager component and the techniques described herein, can desirably (e.g., automatically, dynamically, suitably, reliably, efficiently, enhancedly, and/or optimally) managing, prioritizing, and scheduling DRBs and associated downlink data packets (e.g., PDU sets) for communication of the downlink data packets to devices that are using services, such as XR services or other types of services. The disclosed subject matter, by employing the communication manager component and the techniques described herein, can incorporate and take into account PSI values (or other type of priority levels or values) when determining prioritization and scheduling of DRBs and associated downlink data packets, and can prioritize a DRB for scheduling over another DRB(s) based at least in part on the respective PSI levels of respective individual PDU sets associated with the respective DRBs, which can thereby enhance (e.g., improve) prioritization and scheduling of DRBs over existing techniques for prioritizing and scheduling of DRBs.

Also, the disclosed subject matter, by employing the communication manager component and the techniques described herein, desirably can determine respective delay metrics for respective PSI values (or other type of priority levels or values) to facilitate determining the prioritization and scheduling of DRBs associated with a device. By determining and considering the respective delay metrics associated with the respective PSI values (or other type of priority levels or values), the system (e.g., comprising the RAN and communication manager component) desirably can take PSI values (or other type of priority levels or values) into account for prioritization and scheduling of DRBs associated with the device and/or can prioritize higher importance or priority data (e.g., downlink PDU sets associated with lower PSI values that have higher priority or importance). This can thereby enhance prioritization and scheduling of DRBs over existing techniques for prioritizing and scheduling of DRBs.

Further, the disclosed subject matter, by employing the communication manager component and the techniques described herein, desirably can employ a flexible approach to delay metric determinations that can determine and consider (e.g., take into account) minimum weighted delay across respective (e.g., different) PSI values (or priority levels or values) associated with respective DRBs and respective downlink data packets (e.g., PDU sets) associated therewith. This can provide for an enhanced and more nuanced approach of prioritization and scheduling of DRBs, which can consider both PSI values (or priority levels or values) and delay specifications associated with the downlink data, over and as compared to existing techniques for prioritizing and scheduling of DRBs.

Also, the disclosed subject matter, by employing the communication manager component and the techniques described herein, desirably can employ and fine tune (e.g., dynamically or automatically fine tune) a PSI-to-PSI weight table (or priority level-to-priority level weight table) that can be utilized to facilitate determining respective weighted delay metrics (e.g., weighted packet delay metrics) associated with respective PSI values (or other priority levels or values). For instance, the communication manager component and the techniques described herein can employ (e.g., execute) an algorithm to determine (e.g., dynamically or automatically determine or calculate) respective PSI weight values associated with respective PSI values based at least in part on configurable parameters, such as a maximum threshold weight value and/or a minimum threshold weight value. This adaptability of determining respective weight values associated with respective PSI values (or priority levels or values) desirably can enhance flexibility of the system and can further enhance prioritization and scheduling of DRBs over and as compared to existing techniques for prioritizing and scheduling of DRBs.

Thus, the disclosed subject matter, by employing the communication manager component and the techniques described herein, desirably can employ a holistic approach to prioritizing and scheduling DRBs associated with the device, considering both PSI values (or priority levels or values) and delay specifications associated with the downlink data. The flexibility and adaptability of the disclosed systems, methods, techniques, and algorithms can enhance prioritization and scheduling of DRBs and associated downlink data (e.g., PDU sets) associated with devices, and desirably can address specific challenges posed by certain services, such as XR services, in a RAN environment. The disclosed subject matter, by employing the communication manager component and the techniques described herein, desirably can enhance network performance, QoS, service performance, and quality of experience (QoE) for users of devices and services over and as compared to existing techniques for prioritizing and scheduling of DRBs.

These and other aspects and embodiments of the disclosed subject matter will now be described with respect to the drawings.

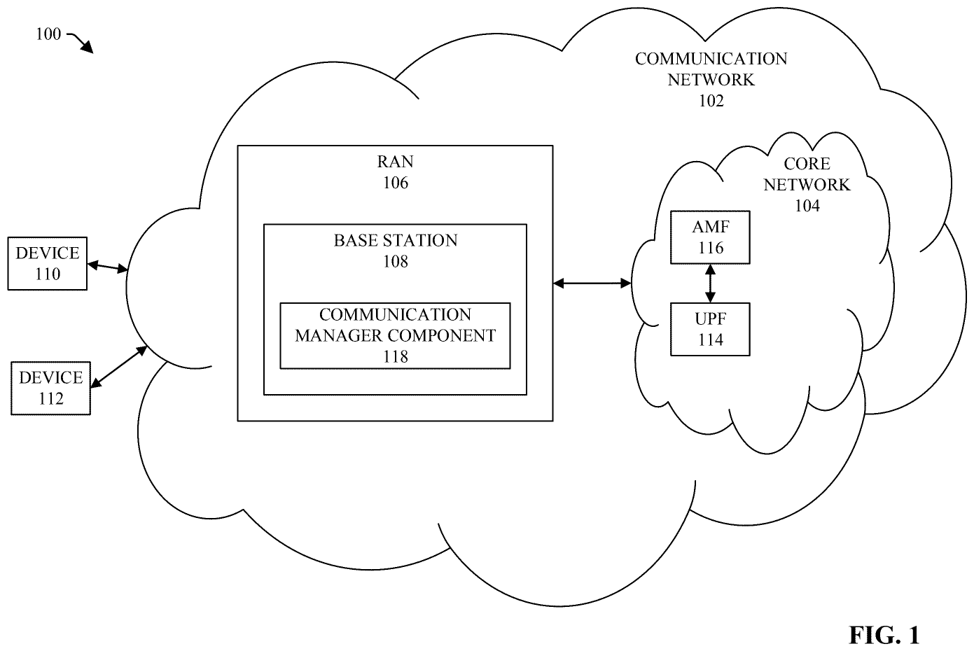

Referring now to the drawings, FIG. 1 illustrates a block diagram of a non-limiting example system 100 that can desirably (e.g., automatically, dynamically, suitably, reliably, efficiently, enhancedly, and/or optimally) enhance management of scheduling and communication of downlink data, such as downlink data packets (e.g., PDU sets), in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as, for example, base station 108, that each can comprise one or more cells (not shown in FIG. 1).

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In certain embodiments, the core network 104 can comprise a UPF node 114, an AMF node 116, and/or other network functions (not shown in FIG. 1 for reasons of brevity and clarity). The UPF node 114 can connect to or interface with the one or more RANs (e.g., RAN 106) and the one or more base stations (e.g., base station 108), can be an interconnect point between the core network 104 and a data network (DN), can provide or facilitate providing a PDU session anchor point for providing mobility associated with radio access technologies (RATs), can provide or facilitate providing data packet routing or forwarding, and/or can perform or manage other functions. The AMF node 116 can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108) can be a 4^{th} generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an XR service or other type of service that can involve or relate to communication of data bursts comprising PDU sets.

As disclosed, certain services, such as XR services, can generate periodic data bursts, wherein each data burst can comprise one or more PDU sets that can be communicated to a device via the RAN and DRBs associated with the device. The respective PDU sets can be associated with a PSDB and respective PSI values, wherein the PSDB can indicate the amount of time budgeted for communicating the respective PDU sets to the device. As disclosed, some existing techniques for scheduling of DRBs and associated downlink data packets (e.g., PDU sets) can be deficient and undesirable in a number of ways, including that such existing techniques can fail to consider PSI values associated with downlink data packets when determining prioritizing and scheduling of DRBs and associated downlink data packets, and can suffer from undesirable oldest data packet bias, as the packet delay metric calculated using such existing techniques can rely on the oldest downlink data packet available at the RAN. This undesirably can potentially lead to a lower priority (e.g., higher PSI value) downlink data packet taking precedence over a higher priority (e.g., lower PSI value) downlink data packet with regard to scheduling of communication of downlink data packets to the device.

The disclosed subject matter can overcome these deficiencies and other problems of existing techniques. To that end, the system 100 can comprise a communication manager component 118 that desirably (e.g., automatically, dynamically, suitably, reliably, efficiently, enhancedly, and/or optimally) can enhance management, prioritization, and scheduling of communication of downlink data (e.g., PDU sets) to devices (e.g., devices 110 and/or 112) for the RAN 106, in accordance with the defined communication management criteria. In some embodiments, the communication manager component 118 can be part of the RAN 106 (e.g., the base station 108 of the RAN 106, as depicted), such as described herein. In other embodiments, the communication manager component 118 can be a standalone component or part of another component, such as a controller (e.g., a RAN intelligent controller (RIC) or other type of controller), associated with the RAN(s)), and/or can be located or situated elsewhere in or associated with the communication network 102, wherein the communication manager component 118 can be associated with (e.g., communicatively connected to) the RAN 106. In certain embodiments, the communication manager component 118 can be employed when certain services, such as an XR service or other service that can involve communication of data bursts comprising PDU sets or similar types of data, are being utilized (e.g., by a device(s) 110 and/or 112 associated with the RAN 106), although, in certain other embodiments, if and as desired, the communication manager component 118 can be employed with regard to any type of service and/or any type of data (e.g., downlink data) that is being utilized or communicated (e.g., by or to a device(s) 110 and/or 112 associated with the RAN 106).

At a desired time(s), the device 110 can be utilizing a desired service to communicate data (e.g., transmit or receive data) via the RAN 106, core network 104, and/or communication network 102. For instance, the device 110 can be utilizing such desired service that can be associated with (e.g., provided or facilitated by) the device 112 and/or the communication network 102. In some embodiments, such desired service can be an XR service or other service that can involve communication of data bursts comprising PDU sets or similar types of data.

In some embodiments, the communication manager component 118 can determine respective DRB delay metrics (e.g., respective DRB delay amounts or values) associated with respective DRBs associated with the device 110 based at least in part on (e.g., as a function of) respective PSI values (e.g., respective priority levels) and the respective packet delay metrics, wherein the respective PSI values can be associated with respective downlink data packets associated with the respective DRBs, and wherein the respective packet delay metrics can be associated with the respective downlink data packets and the respective PSI values, such as described herein. The communication manager component 118 can determine scheduling of communication of the respective downlink data packets associated with the respective DRBs to the device 110 based at least in part on the respective DRB delay metrics, such as described herein. For instance, the communication manager component 118 can prioritize a DRB associated with the smallest (e.g., lowest) DRB delay metric over another DRB(s) associated with a relatively larger (e.g., higher) DRB delay metric for scheduling and communication of downlink data packets to the device 110. In certain embodiments, the respective downlink data packets can be part of respective PDU sets of one or more respective data bursts associated with the service (e.g., an XR service or other type of service) being utilized by the device 110.

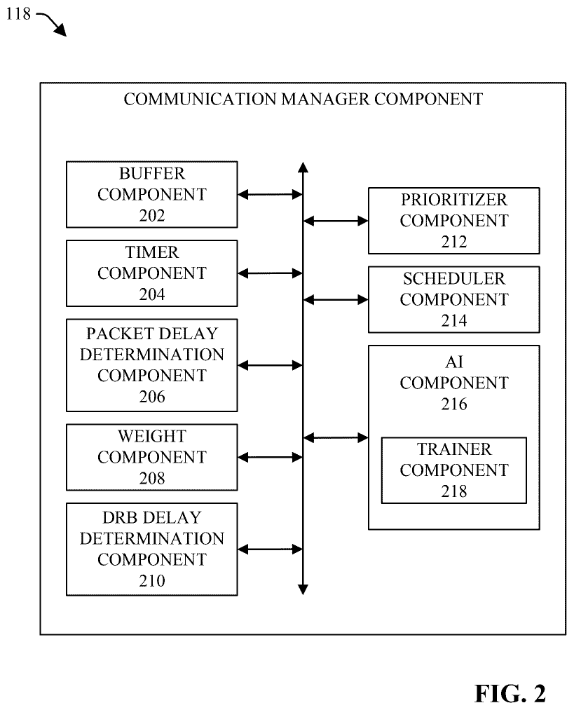

Referring to FIG. 2 (along with FIG. 1), FIG. 2 depicts a block diagram of non-limiting example communication manager component 118 that can enhance management of scheduling and communication of downlink data, such as downlink data packets, for the RAN 106, in accordance with various aspects and embodiments of the disclosed subject matter. The communication manager component 118 can monitor communications of data associated with the device 110 and/or the service (e.g., uplink data transmitted by the device 110 to the RAN 106 (e.g., to the service or device associated therewith, via the RAN 106), and downlink data transmitted to the device (e.g., from the service or device associated therewith to the device 110, via the RAN 106). In accordance with various embodiments, the communication manager component 118 can comprise or be associated with a buffer component 202 that can comprise memory (e.g., volatile and/or non-volatile memory) that can be utilized to store (e.g., temporarily store or buffer) the downlink data that is to be communicated to the device 110. For instance, when the base station 108 receives the downlink data associated with the service from the core network 104 (e.g., from the UPF node 114 of the core network 104), the communication manager component 118 or other component of or associated with the base station 108 can insert and/or store the downlink data in the buffer component 202. This downlink data (e.g., downlink data packets) can be buffered in the buffer component 202 until it is scheduled for communication and communicated to the device 110 by the base station 108.

The communication manager component 118 can track and/or be aware of the respective times that the respective downlink data packets were received from the core network 104 based at least in part on respective time information (e.g., respective time stamps or other respective time indicators) associated with the respective downlink data packets. In some embodiments, the communication manager component 118 can comprise a timer component 204 that can determine or identify the respective times that the respective downlink data packets were received by the RAN 106 from the core network 104, and/or can track respective amounts of time that the respective downlink data packets have been at the RAN 106 (e.g., stored in the buffer component 202) while waiting to be communicated to the device 110. In certain embodiments, the timer component 204 can employ and implement timers that can track or facilitate tracking the respective amounts of time that the respective downlink data packets have been at the RAN 106 while waiting to be communicated to the device 110. For instance, upon the RAN 106 receiving a first PDU of a PDU set, the timer component 204 can start a timer to track the amount of time that the PDU set, or at least the first PDU of the PDU set, has been at the RAN 106 while waiting to be communicated to the device 110.

The downlink data packets can be associated with and subject to a packet delay budget that can indicate a maximum amount (e.g., an upper bound) of time for packet transmission delay for communication of a downlink data packet from the UPF node 114 (or other component of the core network 104) to the device 110. For instance, the PDU sets can be associated with and subject to a PSDB that can indicate a maximum amount of time that a PDU set may be delayed in communication from the UPF node 114 (or other component of the core network 104) to the device 110, in accordance with service specifications. When the data is data traffic associated with an XR service or other type of service that can involve communication of data bursts comprising PDU sets or similar types of data, the packet delay budget can be the same as (e.g., equal or equivalent to) the PSDB. In some embodiments, the AMF node 116 can provide packet delay budget information (e.g., PSDB information) that can indicate the packet delay budget (e.g., PSDB) to the RAN 106 (e.g., to the communication manager component 118 associated with the RAN 106) during session setup (e.g., PDU session setup) associated with the device 110 and/or the service.

The respective downlink data packets (e.g., respective PDU sets) can be associated with respective PSI values, which can indicate the respective importance or priority levels of the respective downlink data packets. In some embodiments, the respective PSI values can range from 0 to 15, wherein lower PSI values associated with downlink data packets can indicate a higher priority or importance level, and higher PSI values associated with downlink data packets can indicate a lower priority or importance level. For example, a PSI of 0 associated with a downlink data packet can indicate a highest priority or importance level, and a PSI of 15 associated with a downlink data packet can indicate a lowest priority or importance level. The UPF node 114 can provide the respective PSI values associated with the respective downlink data packets when or in connection with communicating the respective downlink data packets to the RAN 106. A PSI value associated with a PDU set typically can be the same for and apply to all PDUs belonging to that PDU set. As disclosed, PDU sets can be communicated to the device 110 in data bursts that each can comprise one or more PDU sets. In a data burst comprising multiple PDU sets, the respective PDU sets can comprise the same or different PSI values.

To facilitate determining desirable scheduling of downlink data packets (e.g., PDU sets) to the device 110, the communication manager component 118 can determine the respective downlink data packets that can be available at the RAN 106 (e.g., at RAN equipment, such as the buffer component 202), at a particular time, for scheduling for communication to the device 110. In some instances, there can be multiple DRBs established for the device 110 for the communication of data between the RAN 106 and the device 110. For instance, there can be respective DRBs via which respective downlink data packets can be communicated from the RAN 106 to the device 110. The communication manager component 118 can determine the respective downlink data packets associated with the respective DRBs that can be available at the RAN 106, at the particular time, for scheduling for communication to the device 110.

In some embodiments, the communication manager component 118 can comprise a packet delay determination component 206 that can determine (e.g., calculate) respective packet delay metrics associated with the respective downlink data packets available at the RAN 106 for scheduling for communication to the device 110 based at least in part on (e.g., as a function of) the packet delay budget (e.g., PSDB) and the respective times that the respective downlink data packets were received by the RAN 106. For example, with regard to each PDU set associated with each DRB and a respective priority level, the packet delay determination component 206 can analyze the packet delay budget associated with (e.g., applicable to) the PDU set, the current time, and the time when a first PDU of the PDU set was received by the RAN 106 from the UPF node 114. Based at least in part on the result of such analysis, the packet delay determination component 206 can determine a packet delay metric for the PDU set as being equal to the packet delay budget minus a remaining packet delay budget for the PDU set (e.g., for each PDU set associated with each DRB and a respective priority level, packet delay metric=packet delay budget−(current time−time when the first PDU of the PDU set associated with the DRB and the respective priority level was received by the RAN 106 from the UPF node 114)).

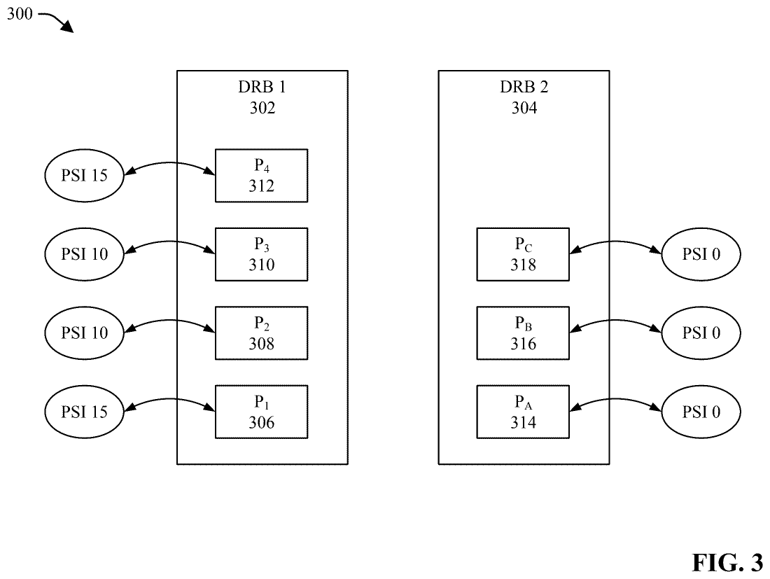

In that regard, referring to FIG. 3 (along with FIGS. 1 and 2), FIG. 3 illustrates a block diagram of non-limiting example DRBs 300 associated with the device 110 in connection with utilization of the service, in accordance with various aspects and embodiments of the disclosed subject matter. In a non-limiting example scenario, the example DRBs 300 can comprise a first DRB 302 (e.g., DRB 1) and a second DRB 304 (e.g., DRB 2) that can be associated with the device 110 (e.g., established by the RAN 106 between the device 110 and the RAN 106) for communication of data, including downlink data, between the RAN 106 and the device 110 in connection with use of the service by the device 110. With regard to the first DRB 302, there can be four PDU sets, comprising a first PDU set 306 (P₁), a second PDU set 308 (P₂), a third PDU set 310 (P₃), and a fourth PDU set 312 (P₄), that can be available at the RAN 106 (e.g., stored in the buffer component 202) for communication to the device 110. With regard to the second DRB 304, there can be three PDU sets, comprising a first PDU set 314 (P_{A}), a second PDU set 316 (P_{B}), and a third PDU set 318 (P_{C}), that can be available at the RAN 106 (e.g., stored in the buffer component 202) for communication to the device 110.

In this example scenario, with regard to the first DRB 302, the first PDU set 306 (P₁) can be the oldest PDU set and the fourth PDU set 312 (P₄) can be the newest or most recent PDU set available at the RAN 106 for communication to the device 110. The first PDU set 306 and the fourth PDU set 312 each can be associated with (e.g., can have) a PSI value of 15 (e.g., the lowest priority or importance level), and the second PDU set 308 and third PDU set 310 each can be associated with a PSI value of 10. Also, in this example scenario, with regard to the second DRB 304, the first PDU set 314 (P_{A}) can be the oldest PDU set and the third PDU set 318 (P_{C}) can be the newest or most recent PDU set available at the RAN 106 for communication to the device 110. Each of the first PDU set 314, second PDU set 316, and third PDU set 318 can be associated with a PSI value of 0 (e.g., the highest priority or importance level). In this example scenario, the first PDU set 306 (P₁) associated with the first DRB 302 can have been received by the RAN 106 before the first PDU set 314 (P_{A}) associated with the second DRB 304 was received by the RAN 106, which can make the first PDU set 306 (P₁) the oldest PDU set overall, of the PDU sets associated with the first DRB 302 and second DRB 304, available to be communicated to the device 110. It is to be appreciated and understood that, in other example scenarios, there can be more than two DRBs associated with the device 110, there can be different PDU sets (e.g., different numbers of PDU sets) associated with the respective DRBs than that of the example scenario, and/or the respective PDU sets can have different PSI values than that of the example scenario.

In this example scenario, the packet delay determination component 206 can determine that, with regard to the first DRB 302, a packet delay metric of the first PDU set 306 (P₁) can be 10 milliseconds (ms), a packet delay metric of the second PDU set 308 (P₂) can be 20 ms, a packet delay metric of the third PDU set 310 (P₃) can be 25 ms, and a packet delay metric of the fourth PDU set 312 (P₄) can be 25 ms, based at least in part on the results of analyzing the packet delay budget, the current time, and the respective times that that respective first PDUs of the respective PDU sets were received by the RAN 106 from the UPF node 114 (or other node of the core network 104). The packet delay determination component 206 also can determine that, with regard to the second DRB 304, a packet delay metric of the first PDU set 314 (P_{A}) can be 15 ms, a packet delay metric of the second PDU set 316 (P_{B}) can be 20 ms, and a packet delay metric of the third PDU set 318 (P_{C}) can be 25 ms based at least in part on the results of analyzing the packet delay budget, the current time, and the respective times that that respective first PDUs of these respective PDU sets were received by the RAN 106 from the UPF node 114 (or other node of the core network 104). Thus, the first PDU set 306 (P₁) associated with the first DRB 302, as the oldest PDU set overall, has a smallest packet delay metric, as compared to the other packet delay metrics associated with the other PDU sets, including the packet delay metric of the first PDU set 314 (P_{A}) associated with the second DRB 304. It is to be appreciated and understood that, in other example scenarios, the respective packet delay metrics associated with the respective PDU sets can be different than the respective example packet delay metrics indicated for this example scenario.

In some embodiments, the packet delay determination component 206 also can determine the respective smallest packet delay metrics associated with the respective PSI values associated with the respective DRBs associated with the device 110. For instance, in the example scenario, with regard to the first DRB 302 and the PSI value of 15, the packet delay determination component 206 can determine that the smallest packet delay metric associated with PSI 15 can be the packet delay metric (e.g., 10 ms) associated with the first PDU set 306 (P₁), based at least in part on the results of analyzing the packet delay metric (e.g., 10 ms) of the first PDU set 306 (P₁) and the packet delay metric (e.g., 25 ms) of the fourth PDU set 312 (P₄) associated with the first DRB 302 and PSI 15. With regard to the first DRB 302 and the PSI value of 10, the packet delay determination component 206 can determine that the smallest packet delay metric associated with PSI 10 can be the packet delay metric (e.g., 20 ms) associated with the second PDU set 308 (P₂), based at least in part on the results of analyzing the packet delay metric (e.g., 20 ms) of the second PDU set 308 (P₂) and the packet delay metric (e.g., 25 ms) of the third PDU set 310 (P₃) associated with the first DRB 302 and PSI 10. With regard to the second DRB 304 and the PSI value of 0, the packet delay determination component 206 can determine that the smallest packet delay metric associated with PSI 0 can be the packet delay metric (e.g., 15 ms) associated with the first PDU set 314 (P_{A}), based at least in part on the results of analyzing the packet delay metric (e.g., 15 ms) of the first PDU set 314 (P_{A}), the packet delay metric (e.g., 20 ms) of the second PDU set 316 (P_{B}), and the packet delay metric (e.g., 25 ms) of the third PDU set 318 (P_{C}) associated with the second DRB 304 and PSI 0.

In certain embodiments, the communication manager component 118 can comprise a weight component 208 that can be utilized to apply respective weight values associated with the respective PSI values to the respective smallest packet delay metrics associated with the respective PSI values and the respective DRBs to determine or generate respective weighted smallest packet delay metrics associated with the respective PSI values and the respective DRBs, in accordance with the defined communication management criteria. For example, the weight component 208 (and/or the packet delay determination component 206 or another component of the communication manager component 118 operating in conjunction with the weight component 208) can apply or facilitate applying a first weight value associated with a first PSI value to a first smallest packet delay metric associated with the first PSI to determine or generate a first weighted smallest packet delay metric associated with the first PSI, a second weight value associated with a second PSI value to a second smallest packet delay metric associated with the second PSI to determine or generate a second weighted smallest packet delay metric associated with the second PSI, a third weight value associated with a third PSI value to a third smallest packet delay metric associated with the third PSI to determine or generate a third weighted smallest packet delay metric associated with the third PSI, and/or another weight value associated with another PSI value to another smallest packet delay metric associated with the other PSI to determine or generate another weighted smallest packet delay metric associated with the other PSI. In certain embodiments, with regard to PSI values, where the lower the PSI value, the higher the importance or priority of the associated downlink data packet (e.g., PDU set) can be, the communication manager component 118 and/or the user can determine, set, apply relatively lower weight values with regard to relatively lower PSI values and relatively higher weight values with regard to relatively higher PSI values, as doing so can facilitate giving more priority, importance, or emphasis (e.g., higher priority, importance, or emphasis) to those smallest packet delay metrics associated with lower PSI values (e.g., higher importance or priority levels).

In some embodiments, the respective weight values associated with the respective PSI values (e.g., a configurable PSI-to-PSI weight table comprising the respective weight values associated with the respective PSI values) can be determined by a user(s) (e.g., an operator, technician, or other user associated with the communication network 102), based at least in part on observations, by the user(s), relating to communication of downlink data to devices, in accordance with the defined communication management criteria. In other embodiments, the communication manager component 118 can determine (e.g., automatically or dynamically determine) the respective weight values associated with the respective PSI values (e.g., a dynamically determined PSI-to-PSI weight table comprising the respective weight values associated with the respective PSI values), in accordance with the defined communication management criteria, such as described herein.

In the example scenario, the communication manager component 118 can employ respective weight values associated with respective PSI values using, and in accordance with, a non-limiting example TABLE 1 comprising respective weight values associated with (e.g., mapped or linked to) respective PSI values, as follows:

TABLE 1

| PSI | PSI Weight |
|---|---|
| 0 | 0.50 |
| 1 | 0.53 |
| 2 | 0.57 |
| 3 | 0.60 |
| 4 | 0.63 |
| 5 | 0.67 |
| 6 | 0.70 |
| 7 | 0.73 |
| 8 | 0.77 |
| 9 | 0.80 |
| 10 | 0.83 |
| 11 | 0.87 |
| 12 | 0.90 |
| 13 | 0.93 |
| 14 | 0.97 |
| 15 | 1.00 |

In the example scenario, the communication manager component 118 can reference, access, and/or analyze the weight value information in TABLE 1. Based at least in part on the weight value information, with regard to the first DRB 302 and the PSI value of 15, the packet delay determination component 206 and/or the weight component 208 can apply a weight value (e.g., PSI weight) of 1.00 to the smallest packet delay metric associated with PSI 15, which can be the packet delay metric (e.g., 10 ms) associated with the first PDU set 306 (P₁), to generate a weighted smallest packet delay metric of 10 ms associated with PSI 15 (e.g., weighted smallest packet delay metric associated with PSI 15=smallest packet delay metric associated with PSI 15 (e.g., 10 ms)*PSI weight associated with PSI 15 (e.g., 1.00)=10 ms). Also, based at least in part on the weight value information, with regard to the first DRB 302 and the PSI value of 10, the packet delay determination component 206 and/or the weight component 208 can apply a weight value (e.g., PSI weight) of 0.83 to the smallest packet delay metric associated with PSI 10, which can be the packet delay metric (e.g., 20 ms) associated with the second PDU set 308 (P₂), to generate a weighted smallest packet delay metric of 16.6 ms associated with PSI 10 (e.g., weighted smallest packet delay metric associated with PSI 10=smallest packet delay metric associated with PSI 10 (e.g., 20 ms)*PSI weight associated with PSI 10 (e.g., 0.83)=16.6 ms). Further, based at least in part on the weight value information, with regard to the second DRB 304 and the PSI value of 0, the packet delay determination component 206 and/or the weight component 208 can apply a weight value (e.g., PSI weight) of 0.50 to the smallest packet delay metric associated with PSI 0, which can be the packet delay metric (e.g., 15 ms) associated with the first PDU set 314 (P_{A}), to generate a weighted smallest packet delay metric of 7.5 ms associated with PSI 0 (e.g., weighted smallest packet delay metric associated with PSI 0=smallest packet delay metric associated with PSI 0 (e.g., 15 ms)*PSI weight associated with PSI 0 (e.g., 0.50)=7.5 ms).

In some embodiments, the communication manager component 118 also can comprise a DRB delay determination component 210 that can determine (e.g., calculate) respective DRB delay metrics associated with respective DRBs associated with a device (e.g., device 110) and/or service being utilized by the device, based at least in part on (e.g., as a function of) the respective weighted smallest packet delay metrics associated with the respective PSI values and the respective DRBs. For instance, with regard to each DRB of one or more DRBs associated with the device 110 and/or the service, the DRB delay determination component 210 can determine the DRB delay metric associated with the DRB as the minimum of the one or more respective weighted smallest packet delay metrics associated with the one or more respective PSI values. To further illustrate, in the example scenario, with regard to the first DRB 302, the DRB delay determination component 210 can determine the DRB delay metric associated with the first DRB 302 as the minimum of the weighted smallest packet delay metric associated with PSI 15 and the weighted smallest packet delay metric associated with PSI 10 (e.g., DRB delay metric associated with the first DRB 302=min (10 ms, 16.6 ms)=10 ms). Also, in the example scenario, with regard to the second DRB 304, the DRB delay determination component 210 can determine the DRB delay metric associated with the second DRB 304 as the minimum of the weighted smallest packet delay metric associated with PSI 0 (e.g., DRB delay metric associated with the second DRB 304=min (7.5 ms)=7.5 ms). Since there is only one PSI associated with the second DRB 304, the DRB delay metric associated with the second DRB 304 essentially can just be equal to the weighted smallest packet delay metric associated with that PSI.

In certain embodiments, the communication manager component 118 can comprise a prioritizer component 212 (e.g., a DRB prioritizer component) that can determine a DRB (and/or associated data packet(s), such as a PDU set(s), available and stored in the buffer component 202) to prioritize for scheduling (e.g., downlink scheduling) for communication to the device 110 based at least in part on the respective DRB delay metrics associated with the device 110 and/or the associated service, in accordance with the defined communication management criteria. For instance, the prioritizer component 212 can determine a DRB, of the DRBs associated with the device 110 and/or associated service, to prioritize for scheduling for communication to the device 110 based at least in part on the smallest DRB delay metric of the respective DRB delay metrics associated with the device 110 and/or the associated service. To illustrate, in the example scenario, the first DRB delay metric associated with the first DRB 302 can be 10 ms (e.g., associated with PSI 15) and the second DRB delay metric associated with the second DRB 304 can be 7.5 ms (e.g., associated with PSI 0). Based at least in part on the results of analyzing the first DRB delay metric and the second DRB delay metric, the prioritizer component 212 can determine that the second DRB delay metric (e.g., 7.5 ms) associated with the second DRB 304 is smaller (e.g., less than) the first DRB delay metric (e.g., 10 ms) associated with the first DRB 302, and, accordingly, can determine that the second DRB 304 is to be prioritized over the first DRB 302 with regard to scheduling communication of data (e.g., downlink data, such as PDU sets) to the device 110. For instance, the prioritizer component 212 can determine that the first PDU set 314 (P_{A}) associated with PSI 0 and associated with the second DRB 304 can be prioritized over the first PDU set 306 (P₁) associated with PSI 15 and associated with the first DRB 302 with regard to scheduling for downlink communication to the device 110.

The communication manager component 118 also can comprise a scheduler component 214 that can schedule downlink communication of respective data packets (e.g., respective PDU sets) associated with the respective DRBs associated with the device 110 and/or associated service based at least in part on (e.g., in accordance with) the DRB and/or data packet prioritization, in accordance with the defined communication management criteria. For instance, the scheduler component 214 can schedule downlink communication of the first PDU set 314 (P_{A}) associated with the second DRB 304 to the device 110 over (e.g., before) scheduling of downlink communication of the first PDU set 306 (P₁) associated with the first DRB 302 to the device 110 based at least in part on the DRB and/or data packet prioritization determined by the prioritizer component 212 (e.g., based at least in part on the second DRB 304 being prioritized over the first DRB 302, at least at this time). In accordance with the scheduling and prioritization, the RAN 106 (e.g., the base station 108 of the RAN) can communicate the first PDU set 314 (P_{A}) associated with the second DRB 304 to the device 110 followed by communication of the first PDU set 306 (P₁) associated with the first DRB 302 to the device 110.

With the communication manager component 118 taking into account respective PSI values along with respective packet delay metrics associated with the respective data packets associated with the respective DRBs, the communication manager component 118 can enhance (e.g., improve or optimize) prioritization and scheduling of the respective data packets to the device 110 over (e.g., as compared to) existing scheduling techniques that take into account which data packets, associated with respective DRBs, are the oldest data packets. For instance, in the example scenario, the communication manager component 118 can prioritize the first PDU set 314 (P_{A}) associated with PSI 0 and associated with the second DRB 304 over the first PDU set 306 (P₁) associated with PSI 15 and associated with the first DRB 302 with regard to scheduling for downlink communication to the device 110, due in part to the first PDU set 314 (P_{A}) having a higher priority level (e.g., lower PSI value) than the first PDU set 306 (P₁), even though the first PDU set 306 (P₁) is an older data packet than the first PDU set 314 (P_{A}) (e.g., the first PDU set 306 (P₁) has been waiting longer than the first PDU set 314 (P_{A}) at the RAN 106 to be scheduled for communication to the device 110). In contrast, with some existing scheduling techniques, the first PDU set 306 (P₁) would be prioritized over the first PDU set 314 (P_{A}) for scheduling of communication to the device due to the first PDU set 306 (P₁) being an older data packet than the first PDU set 314 (P_{A}), even though the first PDU set 306 (P₁) has a lower priority or importance level (e.g., a higher PSI value) than the first PDU set 314 (P_{A}).

With further regard to the weight component 208 and weight values, in certain embodiments, the communication manager component 118, employing the weight component 208, can determine (e.g., automatically or dynamically determine) the respective weight values associated with the respective PSI values, and can determine or generate a corresponding weight table (e.g., PSI-to-PSI weight table) comprising the respective weight values associated with (e.g., mapped or linked to) the respective PSI values, in accordance with the defined communication management criteria. For instance, the weight component 208 can determine the respective weight values to be associated with the respective PSI values, and can determine or generate a corresponding weight table, based at least in part on a minimum threshold weight value (e.g., minimum threshold PSI weight value), a maximum threshold weight value, and/or other factors or characteristics (e.g., a number of PSI values being employed).

As a non-limiting example scenario of determining and generating a weight table, the weight component 208 can receive PSI-related information that can indicate the minimum threshold weight value can be 0.40 and the maximum threshold weight value can be 1.00, with a total of 16 PSI values being available for use in indicating importance or priority of data packets. In some embodiments, the weight component 208 can determine a weight (e.g., a PSI weight) threshold step size as a function of the maximum threshold weight value, the minimum threshold weight value, and the number of PSI values. For example, the weight component 208 can determine a weight threshold step size as being equal to a total of the maximum threshold weight value minus the minimum threshold weight value divided by a total of the number of PSI values minus 1 (e.g., weight threshold step size=(maximum threshold weight value−the minimum threshold weight value)/(number of PSI values−1)).

For each PSI step N, with N being an integer ranging from 0 to 15, corresponding to PSI values 0 to 15 in this example scenario, the weight component 208 can determine a threshold weight value at each Nas a function of the minimum threshold weight value, N, and the weight threshold step size. For example, for each N, the weight component 208 can determine (e.g., calculate) a threshold weight value at N as being equal to the minimum threshold weight value plus a total of N multiplied by the weight threshold step size (e.g., threshold weight value (N)=the minimum threshold weight value+(N*weight threshold step size)). For instance, in the example scenario, the weight component 208 can determine the threshold weight value at N=0 as being equal to 0.40+(0*0.04)=0.40, the threshold weight value at N=1 as being equal to 0.40+(1*0.04)=0.44, the threshold weight value at N=2 as being equal to 0.40+(2*0.04)=0.48, the threshold weight value at N=3 as being equal to 0.40+(3*0.04)=0.52, and so on, up to determining the threshold weight value at N=15 as being equal to 0.40+(15*0.04)=1.00. In certain embodiments, the weight component 208 can generate a weight table that can comprise the respective PSI values and associated weight values (e.g., threshold weight values) corresponding to the respective determined threshold weight values at the respective N values, such as shown in TABLE 2 as follows:

TABLE 2

| PSI | PSI Weight |
|---|---|
| 0 | 0.40 |
| 1 | 0.44 |
| 2 | 0.48 |
| 3 | 0.52 |
| 4 | 0.56 |
| 5 | 0.60 |
| 6 | 0.64 |
| 7 | 0.68 |
| 8 | 0.72 |
| 9 | 0.76 |
| 10 | 0.80 |
| 11 | 0.84 |
| 12 | 0.88 |
| 13 | 0.92 |
| 14 | 0.96 |
| 15 | 1.00 |

The weight component 208 can utilize (e.g., access and reference) this example TABLE 2 when determining the respective weight values to apply to respective packet delay metrics associated with respective PSI values in a same or similar manner as described herein with regard to TABLE 1. It is to be appreciated and understood that different weight tables and associated weight values can be determined (e.g., by the weight component 208 and/or the user) depending in part on the desired maximum threshold weight value, the desired minimum threshold weight value, and/or the desired number of PSI values, in accordance with the defined communication management criteria. The desired maximum threshold weight value, the desired minimum threshold weight value, and/or the desired number of PSI values each can be tunable (e.g., adjustable, configurable, or modifiable) parameters. It also is to be appreciated and understood that the above-disclosed weighting algorithm for determining the weight values for the weight table is but one of various weighting algorithms that the weight component 208 can create and/or utilize for determining respective weight values to be associated with respective PSI values.

In some embodiments, the weight component 208 can create and/or utilize a weight table comprising respective weight values associated with respective PSI values, wherein the weight values can be non-uniform in step size (e.g., the difference in weight values between two adjacent PSI values can be different from another difference in weight values between two other adjacent PSI values). For instance, the weight component 208 can or may determine that it can be desirable (e.g., wanted, suitable, enhanced, or optimal) to have a finer (e.g., smaller) step size for certain PSI values (e.g., lower PSI values, which can have higher priority or importance) and a less granular or less fine (e.g., a larger) step size for other PSI values (e.g., higher PSI values, which can have lower priority or importance).

In certain embodiments, the weight component 208 can create and/or utilize a weight table comprising respective weight values associated with respective PSI values that can be determined based at least in part on one or more various factors or attributes (e.g., characteristics) comprising a type of service (e.g., type of XR service; or XR service or other type of service) being utilized by the device, a type of device (e.g., smart phone, electronic pad or tablet, a computer, an electronic gaming device, an augmented reality (AR)/virtual reality (VR) device or headset device, or other type of device), a time of day (e.g., morning, afternoon, evening, or night; hour of day; weekday or weekend; time of peak device usage or time of non-peak device usage; or other type of time-related factor), a level of network congestion associated with the RAN 106 or other part of the communication network, a user of the device (e.g., different users can have different device or service usage characteristics or preferences), a type of RAN or other network equipment (e.g., capabilities of the RAN or other type of network equipment), and/or another desired factor. For example, the weight component 208 can determine, create, and/or utilize a first weight table comprising respective first weight values associated with respective first PSI values based at least in part on a first group of factors, and can determine, create, and/or utilize a second weight table comprising respective second weight values associated with respective second PSI values based at least in part on a second group of factors, wherein the second weight table can be different from the first weight table.

In accordance with various embodiments, the communication manager component 118 can comprise an artificial intelligence (AI) component 216 that can employ AI and/or machine learning techniques to render (e.g., make) various predictions or determinations relating to enhancing scheduling of downlink communication of data to devices (e.g., device 110 and/or device 112) and/or perform various other operations, such as described herein. The AI component 216 can employ AI, machine learning, and/or other AI-type techniques and algorithms to determine or infer priority levels or PSI values associated with PDU sets, determine, infer, or predict packet delay metrics associated with data packets, determine, infer, or predict DRB delay metrics associated with DRBs, determine or adapt threshold (e.g., maximum, minimum, or other threshold) weight values to use for a weight table or a mapping of PSI values to weight values, determine or adapt a weight threshold step size to utilize for a weight table or a mapping of PSI values to weight values, determine or adapt weight tables for use in determining weighted packet delay metrics, determine or adapt a mapping of PSI values to weight values for use in determining weighted packet delay metrics, determine, infer, or predict a DRB and/or an associated data packet (e.g., PDU set) to prioritize over another DRB(s) and/or associated data packet(s) with regard to downlink communication of data to a device (e.g., device 110 or device 112), determine, infer, or predict a scheduling of downlink communication of respective data packets associated with respective DRBs to a device, and/or perform other desired functions or operations. In some embodiments, the AI component 216 can comprise, generate, and/or train machine learning models that can be trained to determine or infer priority levels or PSI values associated with PDU sets, determine, infer, or predict packet delay metrics associated with data packets, determine, infer, or predict DRB delay metrics associated with DRBs, determine or adapt threshold (e.g., maximum, minimum, or other threshold) weight values to use for a weight table or a mapping of PSI values to weight values, determine or adapt a weight threshold step size to utilize for a weight table or a mapping of PSI values to weight values, determine or adapt weight tables for use in determining weighted packet delay metrics, determine or adapt a mapping of PSI values to weight values for use in determining weighted packet delay metrics, determine, infer, or predict a DRB and/or an associated data packet (e.g., PDU set) to prioritize over another DRB(s) and/or associated data packet(s) with regard to downlink communication of data to a device (e.g., device 110 or device 112), determine, infer, or predict a scheduling of downlink communication of respective data packets associated with respective DRBs to a device, and/or perform other desired functions or operations.

For instance, the AI component 216 can employ a trainer component 218 that can train (or refine or update training of) a (trained) machine learning model to learn to determine or infer priority levels or PSI values associated with PDU sets, determine, infer, or predict packet delay metrics associated with data packets, determine, infer, or predict DRB delay metrics associated with DRBs, determine or adapt threshold (e.g., maximum, minimum, or other threshold) weight values to use for a weight table or a mapping of PSI values to weight values, determine or adapt a weight threshold step size to utilize for a weight table or a mapping of PSI values to weight values, determine or adapt weight tables for use in determining weighted packet delay metrics, determine or adapt a mapping of PSI values to weight values for use in determining weighted packet delay metrics, determine, infer, or predict a DRB and/or an associated data packet (e.g., PDU set) to prioritize over another DRB(s) and/or associated data packet(s) with regard to downlink communication of data to a device (e.g., device 110 or device 112), determine, infer, or predict a scheduling of downlink communication of respective data packets associated with respective DRBs to a device, and/or perform other desired functions or operations, based at least in part on application of training data and/or feedback information relating to communication sessions (e.g., current or previous communication sessions associated with a device(s)), services (e.g., XR services or other type of service), prioritizing (e.g., current or previous prioritizing) of DRBs and associated data packets for scheduling of downlink communication of data packets to a device, scheduling (e.g., current or previous scheduling) of downlink communication of data packets to a device, packet delay metrics, DRB delay metrics, PSI values (or other priority values or levels), weight values, threshold values, the defined communication management criteria, and/or other data to the (trained) machine learning model. Such training of the (trained) machine learning model can enable the trained machine learning model to learn to determine or infer priority levels or PSI values associated with PDU sets, determine, infer, or predict packet delay metrics associated with data packets, determine, infer, or predict DRB delay metrics associated with DRBs, determine or adapt threshold (e.g., maximum, minimum, or other threshold) weight values to use for a weight table or a mapping of PSI values to weight values, determine or adapt a weight threshold step size to utilize for a weight table or a mapping of PSI values to weight values, determine or adapt weight tables for use in determining weighted packet delay metrics, determine or adapt a mapping of PSI values to weight values for use in determining weighted packet delay metrics, determine, infer, or predict a DRB and/or an associated data packet (e.g., PDU set) to prioritize over another DRB(s) and/or associated data packet(s) with regard to downlink communication of data to a device (e.g., device 110 or device 112), determine, infer, or predict a scheduling of downlink communication of respective data packets associated with respective DRBs to a device, and/or perform or automate other desired functions or operations.

In certain embodiments, the trained machine learning model can perform a machine learning-based analysis on information and/or feedback information relating to communication sessions (e.g., current or previous communication sessions associated with a device(s)), services (e.g., XR services or other type of service), prioritizing (e.g., current or previous prioritizing) of DRBs and associated data packets for scheduling of downlink communication of data packets to a device, scheduling (e.g., current or previous scheduling) of downlink communication of data packets to a device, PSDBs, packet delay metrics, DRB delay metrics, PSI values (or other priority values or levels), weight values, threshold values, the defined communication management criteria, and/or the other desired information. Based at least in part on the results of the machine learning-based analysis on such information, the trained machine learning model can determine or infer priority levels or PSI values associated with PDU sets, determine, infer, or predict packet delay metrics associated with data packets, determine, infer, or predict DRB delay metrics associated with DRBs, determine or adapt threshold (e.g., maximum, minimum, or other threshold) weight values to use for a weight table or a mapping of PSI values to weight values, determine or adapt a weight threshold step size to utilize for a weight table or a mapping of PSI values to weight values, determine or adapt weight tables for use in determining weighted packet delay metrics, determine or adapt a mapping of PSI values to weight values for use in determining weighted packet delay metrics, determine, infer, or predict a DRB and/or an associated data packet (e.g., PDU set) to prioritize over another DRB(s) and/or associated data packet(s) with regard to downlink communication of data to a device (e.g., device 110 or device 112), determine, infer, or predict a scheduling of downlink communication of respective data packets associated with respective DRBs to a device, and/or perform or automate other desired functions or operations. For example, based at least in part on the machine learning-based analysis results, the trained machine learning model can determine whether there are one or more data patterns in the data that can indicate an adaptation that can be made to a weight table or a mapping of PSI values to weight values, and/or an adaptation that can be made to the parameters (e.g., maximum threshold weight value, minimum threshold weight value, weight threshold step size, and/or number of PSI values) used to determine such weight table or mapping, to facilitate determining DRB delay metrics and determining prioritization of DRBs and scheduling of data packets associated with DRBs. In some embodiments, the trained machine learning model can determine a probability (e.g., probability value) that a particular adaptation to a weight table or a mapping of PSI values to weight values, and/or a certain adaptation that can be made to a parameter(s) relating thereto, can be desirable (e.g., suitable, usable, or optimal) to improve or further improve determinations of DRB delay metrics and determinations of prioritization of DRBs and scheduling of data packets associated with DRBs. The communication manager component 118, AI component 216, or the trained machine learning model can determine whether the particular adaptation to the weight table or the mapping, and/or the certain adaptation to the parameter(s) relating thereto, can be desirable (e.g., suitable, usable, or optimal) and/or is to be implemented based at least in part on the respective probability and a respective threshold probability (e.g., a respective threshold probability value) relating to weight tables, mappings, and/or parameters relating thereto, and/or based at least in part on whether there are one or more data patterns in the data that can indicate whether the particular adaptation to the weight table or the mapping, and/or the certain adaptation to the parameters relating thereto, can be desirable to improve or further improve determinations of DRB delay metrics and determinations of prioritization of DRBs and scheduling of data packets associated with DRBs.

For instance, the communication manager component 118, AI component 216, or the trained machine learning model can compare the respective probability (e.g., the probability relating to the weight table, the mapping, or the parameter(s)) to the respective threshold probability (e.g., the threshold probability relating to the weight table, the mapping, or the parameter(s)) to determine whether the respective probability satisfies (e.g., meets or exceeds; is at or greater than) the respective threshold probability. If, based at least in part on the results of such comparison, the communication manager component 118, AI component 216, or the trained machine learning model determines that the respective probability does not satisfy (e.g., is less than) the respective threshold probability, the communication manager component 118, AI component 216, or the trained machine learning model can determine that the particular adaptation to the weight table or the mapping, and/or the certain adaptation to the parameter(s) relating thereto, is not desirable (e.g., not suitable, usable, or optimal) to improve or further improve determinations of DRB delay metrics and determinations of prioritization of DRBs and scheduling of data packets associated with DRBs. If, instead, based at least in part on the comparison results, the communication manager component 118, AI component 216, or the trained machine learning model determines that the respective probability does satisfy the respective threshold probability, the communication manager component 118, AI component 216, or the trained machine learning model can determine that the particular adaptation to the weight table or the mapping, and/or the certain adaptation to the parameter(s) relating thereto, can be desirable and/or can be implemented to improve or further improve determinations of DRB delay metrics and determinations of prioritization of DRBs and scheduling of data packets associated with DRBs.

The AI component 216 can perform an AI and/or machine learning-based analysis on data, such as information relating to files, services, applications, communication networks, communication sessions, PDU sets, DRBs, RANs, cells, resources, operational states, congestion information or indicators, devices, users, timers, packet delay metrics, DRB delay metrics, PSI or priority values or levels, weight tables, mappings of PSI values to weight values, weight values, threshold weight values, training data, feedback information, data processing operations, messages, notifications, alarms, alerts, preferences (e.g., user or client preferences), hash values, metadata, parameters, traffic flows, policies, the defined communication management criteria, interfaces, protocols, tools, and/or other information, such as more fully described herein. In connection with or as part of such an AI or machine learning-based analysis, the AI component 216 can employ, build (e.g., construct or create), and/or import, AI and/or machine learning techniques and algorithms, AI and/or machine learning models (e.g., trained models), neural networks (e.g., trained neural networks), Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about relationships between components (e.g., base stations, cells, network nodes, communication links, devices, or other components or functions) of or associated with the communication network 102, determining or learning about PSI or priority levels or values associated with PDU sets, determining or learning about packet delay metrics, determining or learning about DRB delay metrics, determining or learning about weight tables or mappings of PSI values to weight values (e.g., determining or learning about the effects of adapting a weight table, a mapping, or a parameter(s) relating thereto), determining or learning about congestion conditions associated with RANs, determining or learning about prioritization of DRBs and associated data packets for scheduling of downlink communication of data packets to devices, performing other desired functions or operations, and/or automating one or more functions or features of the disclosed subject matter, as more fully described herein.

Based at least in part on the results of the analysis, the AI component 216 can determine, train, and generate one or more models (e.g., machine learning model or other model), such as described herein, wherein the models can model or be representative of respective features and/or respective historical performance of the communication network, RAN, cells, communication manager component, DRBs, services, devices, and/or other functions, features, or operations, such as described herein. The AI component 216 can update (e.g., modify, adjust, refine, or change), and further train and enhance, the model as additional data (e.g., information relating to further operation of or modifications to the communication network, RAN, cells, communication manager component, DRBs, services, devices, and/or other functions, features, or operations; output results output from the machine learning model; the feedback information; and/or other information) is received and analyzed by the AI component 216 or model. In some embodiments, as part of the data analysis, and the determining and training of the models, the AI component 216 can employ (and/or train) Markov chains, a neural network(s), or other AI-based or machine learning-based modeling, techniques, functions, or algorithms.

The AI component 216 can employ various AI-based or machine learning-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 216 can examine the entirety or a subset of the data (e.g., the training data; the operational data relating to the communication network, the RAN, the devices, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

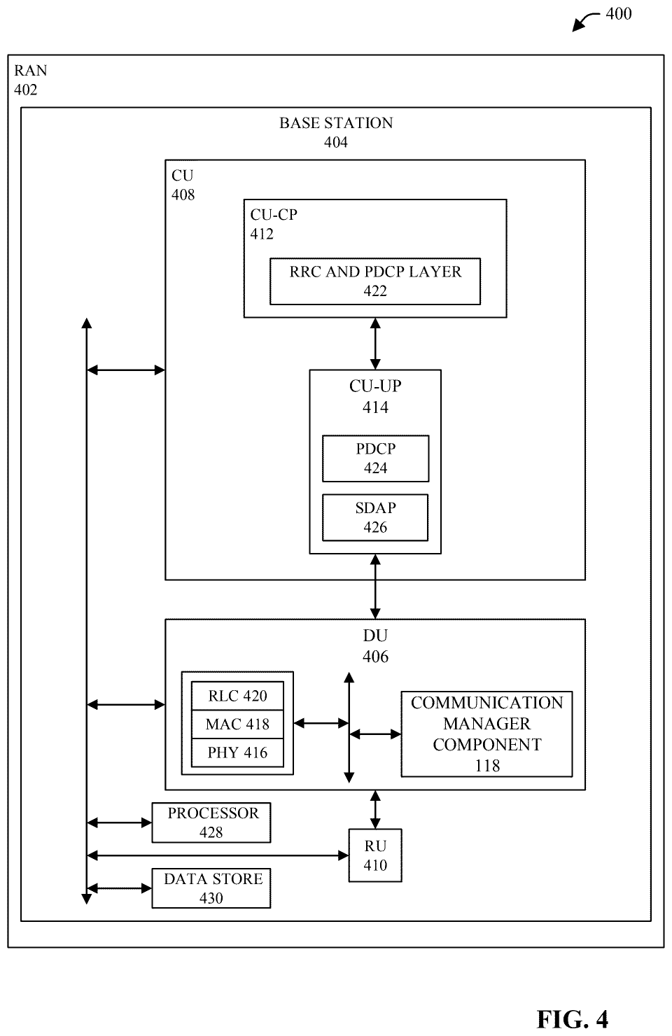

Turning to FIG. 4 (along with FIGS. 1 and 2), FIG. 4 illustrates a block diagram of non-limiting example system 400 that can comprise the RAN 402, which can comprise the communication manager component 118 (e.g., in or associated with a base station 404 of the RAN 402) that can desirably (e.g., automatically, dynamically, suitably, reliably, efficiently, enhancedly, and/or optimally) enhance management of scheduling and communication of downlink data (e.g., PDU sets), in accordance with various aspects and embodiments of the disclosed subject matter. In some embodiments, the system 400 can be part of the system 100 depicted in FIG. 1.

In some embodiments, the RAN 402 can be an open-RAN (O-RAN) that can be part of an O-RAN architecture and environment (e.g., the communication network 102 can employ an O-RAN architecture and environment). In certain embodiments, the RAN 402 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 402 may not be an O-RAN, C-RAN, or vRAN.

In accordance with various embodiments, the RAN 402 and associated communication network (e.g., communication network 102) can be part of a fifth generation (5G) or other new radio (NR) communication environment (e.g., an xG communication environment, wherein x can be 5 or a number greater than 5). With regard to 5G or other NR generation, the RAN 402 can comprise base stations, such as a gNodeB (gNB or NR-NB), that can be disaggregated into a central unit (CU) (e.g., gNB or other NR-NB CU), comprising a CU-user plane (CU-UP) (e.g., gNB or other NR-NB CU-UP), a CU-control plane (CU-CP) (e.g., gNB or other NR-NB CU-CP), and a distributed unit (DU) (e.g., gNB or other NR-NB DU). The CU-UP and DU can be part of the user plane node, with the CU-UP hosting packet data convergence protocol (PDCP) and service data adaption protocol (SDAP) entities, and the DU can host the radio link control (RLC), medium access control (MAC), and physical (PHY) layers.

For instance, the RAN 402 can comprise the base station 404 that can comprise a DU 406, a CU 408, and a radio unit (RU) 410 (e.g., a gNB or other NR-NB RU). The CU 408 can comprise a CU-CP 412 (also referred to as a CU-CP node) and a CU-UP 414 (also referred to as a CU-UP node). In accordance with various embodiments, the DU 406 (as depicted), the CU-UP 414, or another component of or associated with the base station 404 can comprise or be associated with the communication manager component 118, which can comprise various components and functions, and can perform various operations, such as described herein. In certain embodiments, the RAN 402 and/or the base station 404 can comprise multiple DUs, multiple CU-CPs, multiple CU-UPs, and/or multiple RUs.

The DU 406 can be a logical node that can host or handle baseband (e.g., PHY) 416 and layer 2 (L2) (e.g., a MAC layer 418 and a RLC layer 420) functionality associated with the base station 404. The CU-CP 412 can be a logical node that can host or handle layer 3 (L3) (e.g., a radio resource control (RRC) and PDCP layer 422) control plane functionality associated with the base station 404. The CU-UP 414 can be a logical node that can host or handle data traffic between the core network 104 (e.g., 5G core network) and one or more DUs (e.g., the DU 406) to which the CU-UP 414 is connected. In some embodiments, the CU-UP 414 can comprise a PDCP component (PDCP) 424 that can perform PDCP functions, and an SDAP component (SDAP) 426 that can perform SDAP functions. In certain embodiments, the communication manager component 118 can comprise or be associated with all or part of the PDCP component 424, wherein the PDCP component 424 can maintain information relating to weight values and PSI or priority values (e.g., weight table(s), weight values, PSI values, a mapping of respective weight values to respective PSI values (or priority levels), maximum threshold weight value, minimum threshold weight value, and/or other information). The RU 410 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 402 and other devices (e.g., devices 110 and/or 112) or components (e.g., components or functions of the core network 104 or communication network 102).

In certain embodiments, as disclosed, the system 400 can comprise an O-RAN architecture and environment, and the RAN 402 can be an O-RAN. In some embodiments, in the O-RAN architecture and environment, the system 400 also can comprise a service management and orchestration (SMO) component and a RIC (not shown in FIG. 4), wherein the SMO component can be associated with (e.g., communicatively connected to) the RIC and/or the RAN 402 (and/or one or more other RANs) via an interface(s) (e.g., an O1 interface, an A1 interface, or another interface), to facilitate communication of information between the SMO component and the RIC and/or the RAN 402 (and/or one or more other RANs), and the RIC can be associated with the RAN 402 (and/or one or more other RANs) via an interface(s) (e.g., an E2 interface or another interface), to facilitate communication of information between the RIC and the RAN 402 (and/or one or more other RANs).

The SMO component can act and operate as a management and orchestration layer that can control configuration and automation aspects of the RIC and RAN elements of the RAN(s). The SMO component can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time. The RIC can operate to control (e.g., manage) and enhance (e.g., improve or optimize) RAN functions and services of the RAN(s). At least some of the various network functions and components of the RIC can operate in real time or near real time, and some network functions and components of the RIC may operate in non-real time.

In accordance with various embodiments, the RAN 402 can comprise a processor component 428 that can be associated with (e.g., communicatively connected to) and can work in conjunction with other components of the RAN 402, including the base station 404, the DU 406, the CU 408, the RU 410, the communication manager component 118, a data store 430, and/or other components of the RAN 402, to facilitate performing the various functions and operations of the RAN 402. The processor component 428 can employ one or more processors (e.g., one or more central processing units (CPUs)), microprocessors, or controllers that can process information relating to data, files, services, applications, communication networks, RANs, cells, devices, users, resources, communication sessions (e.g., PDU or other communication sessions), PDU sets, DRBs, grants (e.g., downlink or uplink periodic grants or configured grants), downlink control information (DCI), timers, PSDBs, packet delay metrics, DRB delay metrics, PSI or priority values or levels, weight tables, mappings of PSI values to weight values, weight values, threshold (e.g., maximum or minimum threshold) weight values, training data, feedback information, congestion information or indicators, data processing operations, messages, notifications, alarms, alerts, preferences (e.g., user or client preferences), hash values, metadata, parameters, traffic flows, policies, the defined communication management criteria, algorithms (e.g., enhanced communication management algorithms, enhanced prioritization and/or scheduling algorithms for prioritization and scheduling of DRBs and associated downlink data packets, hash algorithms, data compression algorithms, data decompression algorithms, and/or other algorithm), interfaces, protocols, tools, and/or other information, to facilitate operation of the RAN 402, and control data flow between the RAN 402 and/or other components (e.g., network components, another RAN, the communication network 102, a device (e.g., 110 or 112), a node, a service, a user, or other entity) associated with the RAN 402.

The data store 430 can store data structures (e.g., user data, metadata), code structure(s) (e.g., modules, objects, hashes, classes, procedures) or instructions, information relating to data, files, services, applications, communication networks, RANs, cells, devices, users, resources, communication sessions (e.g., PDU or other communication sessions), PDU sets, DRBs, grants (e.g., downlink or uplink periodic grants or configured grants), downlink control information (DCI), timers, PSDBs, packet delay metrics, DRB delay metrics, PSI or priority values or levels, weight tables, mappings of PSI values to weight values, weight values, threshold (e.g., maximum or minimum threshold) weight values, training data, feedback information, congestion information or indicators, data processing operations, messages, notifications, alarms, alerts, preferences (e.g., user or client preferences), hash values, metadata, parameters, traffic flows, policies, the defined communication management criteria, algorithms (e.g., enhanced communication management algorithms, enhanced prioritization and/or scheduling algorithms for prioritization and scheduling of DRBs and associated downlink data packets, hash algorithms, data compression algorithms, data decompression algorithms, and/or other algorithm), interfaces, protocols, tools, and/or other information, to facilitate controlling or performing operations associated with the RAN 402. The data store 430 can comprise volatile and/or non-volatile memory, such as described herein. In an aspect, the processor component 428 can be functionally coupled (e.g., through a memory bus) to the data store 430 in order to store and retrieve information desired to operate and/or confer functionality, at least in part, to the base station 404, DU 406, CU 408, RU 410, communication manager component 118, processor component 428, data store 430, and/or other component of the RAN 402, and/or substantially any other operational aspects of RAN 402.

As disclosed, the data store 430 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

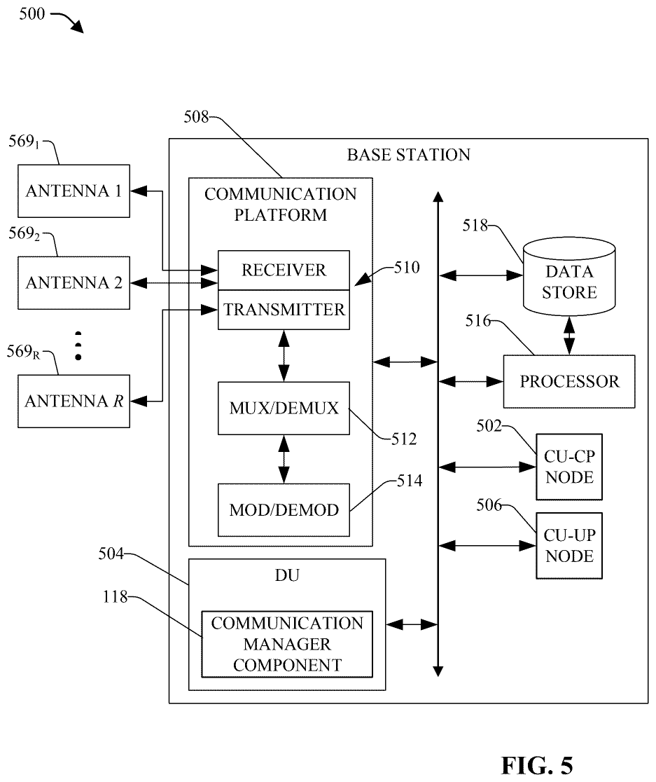

Turning to FIG. 5, FIG. 5 depicts a diagram of a non-limiting example base station 500 that can desirably facilitate (e.g., enable) connections (e.g., wireless connections) and communication of information associated with devices, in accordance with various aspects and embodiments of the disclosed subject matter. In some embodiments, the base station 500 can be a 5G or other NR base station (e.g., gNB or other NR-type or xG base station, wherein x can be a number greater than 5). In other embodiments, the base station 500 can be a 4G or LTE base station, or some other type of base station (e.g., other type of access point).

With regard to a 5G or other NR base station, the base station 500 can comprise a CU-CP node 502 (e.g., a gNB or other NR-NB CU-CP node), one or more DUs (e.g., a gNB or other NR-NB DUs), including DU 504, a desired number of CU-UP nodes (e.g., a gNB or other NR-NB CU-UP nodes), including CU-UP node 506, and/or other network equipment. The CU-CP node 502 can be associated or interfaced with the DUs (e.g., DU 504) via an interface (e.g., F1-C interface) or connection. The CU-CP node 502 can be associated or interfaced with the CU-UP nodes (e.g., CU-UP node 506) via an interface (e.g., E1 interface) or connection. The one or more CU-UP nodes (e.g., CU-UP node 506) can be associated or interfaced with the one or more DUs (e.g., DU 504) via an interface (e.g., F1-U interface) or connection.

A DU (e.g., DU 504) can provide support for lower layers of a protocol stack. For instance, a DU (e.g., DU 504) can be a logical node that can host or handle baseband (e.g., PHY) and L2 (e.g., MAC and RLC layer) functionality associated with the base station 500. A CU-UP node (e.g., CU-UP node 506) can be a logical node that can host or handle data traffic between the core network 104 (e.g., 5G or other NR or xG core network) and the DU(s) (e.g., DU 504) to which the particular CU-UP is connected. The CU-CP node 502 can be a logical node that can host or handle L3 (e.g., RRC and packet data convergence protocol (PDCP) layer) control plane functionality associated with the base station 500.

In some embodiments, a device(s) (e.g., device(s) 110 and/or 112) can be connected to the base station 500, via the DU 504, wherein the CU-UP node 506 and the DU 504 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 500.

The base station 500 can receive and transmit signal(s) from and to wireless devices like access points (e.g., base stations, femtocells, picocells, or other type of access point), access terminals (e.g., UEs), wireless ports and routers, and the like, through a set of antennas 5691-569R. In an aspect, the antennas 5691-569R can be a part of a communication platform 508, which comprises electronic components and associated circuitry that can provide for processing and manipulation of received signal(s) and signal(s) to be transmitted. In an aspect, the communication platform 508 can include a receiver/transmitter 510 that can convert signal from analog to digital upon reception, and from digital to analog upon transmission. In addition, receiver/transmitter 510 can divide a single data stream into multiple, parallel data streams, or perform the reciprocal operation. In accordance with various embodiments, the communication platform 508 can be, can comprise, or can be associated with an RU (e.g., a gNB or other NR-NB RU node).

In an aspect, coupled to receiver/transmitter 510 can be a multiplexer/demultiplexer (mux/demux) 512 that can facilitate manipulation of signal in time and frequency space. The mux/demux 512 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 512 can scramble and spread information (e.g., codes) according to substantially any code known in the art, e.g., Hadamard-Walsh codes, Baker codes, Kasami codes, polyphase codes, and so on. A modulator/demodulator (mod/demod) 514 also can be part of the communication platform 508, and can modulate information according to multiple modulation techniques, such as frequency modulation, amplitude modulation (e.g., M-ary quadrature amplitude modulation (QAM), with M a positive integer), phase-shift keying (PSK), and the like.

The base station 500 also can comprise a processor(s) 516 that can be configured to confer and/or facilitate providing functionality, at least partially, to substantially any electronic component in or associated with the base station 500. For instance, the processor(s) 516 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 500 can include a data store 518 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices, users, applications, services, communication networks, RANs, cells, resources, communication sessions, PDU sets, DRBs, grants, DCI, timers, PSDBs, packet delay metrics, DRB delay metrics, PSI or priority values or levels, weight tables, mappings of PSI values to weight values, weight values, threshold weight values, training data, feedback information, congestion information or indicators, data processing operations, messages, notifications, alarms, alerts, preferences, hash values, metadata, parameters, traffic flows, policies, rules, the defined communication management criteria, algorithms (e.g., enhanced communication management algorithms, enhanced prioritization and/or scheduling algorithms for prioritization and scheduling of DRBs and associated downlink data packets, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 516 can employ one or more processors (e.g., one or more CPUs), microprocessors, or controllers) that can process information, and can be coupled to the data store 518 in order to store and retrieve at least some of the information (e.g., information, such as algorithms, relating to multiplexing/demultiplexing or modulation/demodulation; information relating to radio link levels; information relating to data, files, services, applications, devices, communication conditions associated with devices, users, communication networks, RANs, cells, resources, communication sessions, PDU sets, DRBs, grants, DCI, timers, PSDBs, packet delay metrics, DRB delay metrics, PSI or priority values or levels, weight tables, mappings of PSI values to weight values, weight values, threshold weight values, training data, feedback information, congestion information or indicators, data processing operations, messages, notifications, alarms, alerts, preferences, hash values, metadata, parameters, traffic flows, policies, rules, the defined communication management criteria, algorithms, interfaces, protocols, tools, and/or other information) desired to operate and/or confer functionality to the communication platform 508 and/or other operational components of the base station 500.

The data store 518 can comprise volatile memory and/or nonvolatile memory. By way of example and not limitation, nonvolatile memory can include ROM, PROM, EPROM, EEPROM, flash memory, NVMe, NVMe-oF, PMEM, or PMEM-oF. Volatile memory can include RAM, which can act as external cache memory. By way of example and not limitation, RAM can be available in many forms such as SRAM, DRAM, SDRAM, DDR SDRAM, ESDRAM, SLDRAM, and DRRAM. Memory of the disclosed aspects are intended to comprise, without being limited to, these and other suitable types of memory.

In accordance with various embodiments, the base station 500 (e.g., the DU 504 (as depicted), the CU-UP node 506, or another node of or associated with the base station 500) can comprise or be associated with the communication manager component 118 that desirably (e.g., automatically, dynamically, suitably, reliably, efficiently, enhancedly, and/or optimally) can enhance management, prioritization, and scheduling of communication of downlink data (e.g., PDU sets) to devices for the RAN 106, in accordance with the defined communication management criteria, such as described herein.

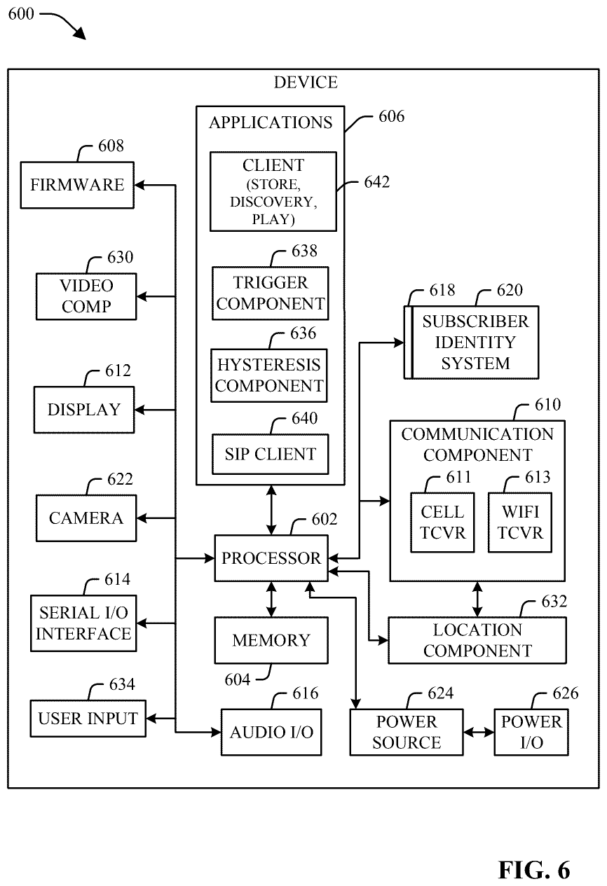

Referring to FIG. 6, FIG. 6 illustrates a diagram of a non-limiting example device 600 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 600 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 600, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 600 can include a processor(s) 602 for controlling and processing all onboard operations and functions. The processor(s) 602 can comprise one or more processors (e.g., one or more central processing units (CPUs)), microprocessors, or controllers) that can process information associated with the device 600. A memory 604 can interface to the processor(s) 602 for storage of data and one or more applications 606 (e.g., a video player software, user feedback component software, etc.). Other applications can include voice recognition of predetermined voice commands that facilitate initiation of the user feedback signals. The applications 606 can be stored in the memory 604 and/or in a firmware 608, and executed by the processor(s) 602 from either or both the memory 604 or/and the firmware 608. The firmware 608 can also store startup code for execution in initializing the device 600. A communication component 610 interfaces to the processor(s) 602 to facilitate wired/wireless communication with external systems, e.g., cellular networks, VoIP networks, and so on. Here, the communication component 610 can also include a suitable cellular transceiver 611 (e.g., a global system for mobile communication (GSM), orthogonal frequency division multiple access (OFDMA), 4G, LTE, 5G, other NR, or other type of transceiver) and/or an unlicensed transceiver 613 (e.g., Wi-Fi, WiMax) for corresponding signal communications. The device 600 can be a device such as a cellular telephone, a PDA with mobile communications capabilities, and messaging-centric devices. The communication component 610 also facilitates communications reception from terrestrial radio networks (e.g., broadcast), digital satellite radio networks, and Internet-based radio services networks.

The device 600 includes a display 612 for displaying text, images, video, telephony functions (e.g., a Caller ID function), setup functions, and for user input. For example, the display 612 can also be referred to as a “screen” that can accommodate the presentation of multimedia content (e.g., music metadata, messages, wallpaper, graphics, etc.). The display 612 can also display videos and can facilitate the generation, editing and sharing of video quotes. A serial I/O interface 614 is provided in communication with the processor(s) 602 to facilitate wired and/or wireless serial communications (e.g., USB, and/or IEEE 1394) through a hardwire connection, and other serial input devices (e.g., a keyboard, keypad, and mouse). This supports updating and troubleshooting the device 600, for example. Audio capabilities are provided with an audio I/O component 616, which can include a speaker for the output of audio signals related to, for example, indication that the user pressed the proper key or key combination to initiate the user feedback signal. The audio I/O component 616 also facilitates the input of audio signals through a microphone to record data and/or telephony voice data, and for inputting voice signals for telephone conversations.

The device 600 can include a slot interface 618 for accommodating a SIC (Subscriber Identity Component) in the form factor of a card Subscriber Identity Module (SIM) or universal SIM 620, and interfacing the SIM card 620 with the processor(s) 602. However, it is to be appreciated that the SIM card 620 can be manufactured into the device 600, and updated by downloading data and software.

The device 600 can process IP data traffic through the communication component 610 to accommodate IP traffic from an IP network such as, for example, the Internet, a corporate intranet, a home network, a person area network, etc., through an ISP or broadband cable provider. Thus, VOIP traffic can be utilized by the device 600 and IP-based multimedia content can be received in either an encoded or a decoded format.

A video processing component 622 (e.g., a camera) can be provided for decoding encoded multimedia content. The video processing component 622 can aid in facilitating the generation, editing, and sharing of video quotes. The device 600 also includes a power source 624 in the form of batteries and/or an AC power subsystem, which power source 624 can interface to an external power system or charging equipment (not shown) by a power I/O component 626.

The device 600 can also include a video component 630 for processing video content received and, for recording and transmitting video content. For example, the video component 630 can facilitate the generation, editing and sharing of video quotes. A location tracking component 632 facilitates geographically locating the device 600. As described hereinabove, this can occur when the user initiates the feedback signal automatically or manually. A user input component 634 facilitates the user initiating the quality feedback signal. The user input component 634 can also facilitate the generation, editing and sharing of video quotes. The user input component 634 can include such conventional input device technologies such as a keypad, keyboard, mouse, stylus pen, and/or touch screen, for example.

Referring again to the applications 606, a hysteresis component 636 facilitates the analysis and processing of hysteresis data, which is utilized to determine when to associate with the access point. A software trigger component 638 can be provided that facilitates triggering of the hysteresis component 636 when the Wi-Fi transceiver 613 detects the beacon of the access point. A SIP client 640 enables the device 600 to support SIP protocols and register the subscriber with the SIP registrar server. The applications 606 can also include a client 642 that provides at least the capability of discovery, play and store of multimedia content, for example, music.

The device 600, as indicated above related to the communication component 610, includes an indoor network radio transceiver 613 (e.g., Wi-Fi transceiver). This function supports the indoor radio link, such as IEEE 802.11, for the dual-mode GSM device (e.g., device 600). The device 600 can accommodate at least satellite radio services through a device (e.g., handset device) that can combine wireless voice and digital radio chipsets into a single device (e.g., single handheld device).

It is to be appreciated and understood that one or more components (e.g., the devices, discard manager component, base station, core network, or other component) of the systems (e.g., system 100, system 400, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

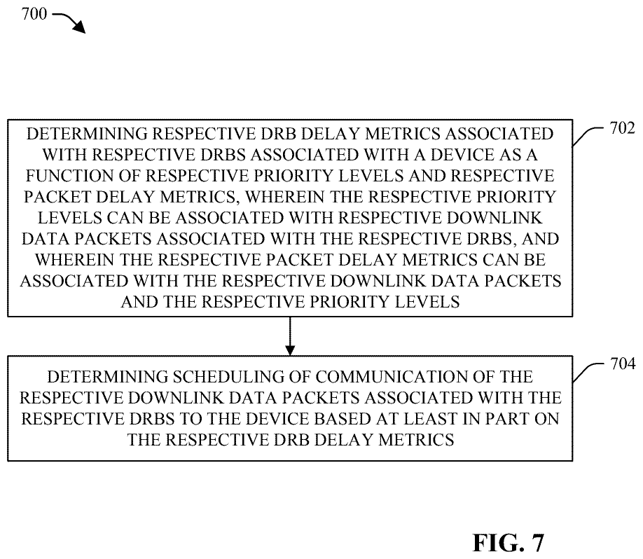

In view of the example systems and/or devices described herein, example methods that can be implemented in accordance with the disclosed subject matter can be further appreciated with reference to flowcharts in FIGS. 7-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can desirably (e.g., automatically, dynamically, suitably, reliably, efficiently, enhancedly, and/or optimally) enhance management of scheduling and communication of downlink data (e.g., PDU sets), in accordance with various aspects and embodiments of the disclosed subject matter. The method 700 can be employed by, for example, a system comprising the communication manager component, which can comprise or be associated with the processor component, the data store, and/or other components.

At 702, respective DRB delay metrics associated with respective DRBs associated with a device can be determined as a function of respective priority levels and respective packet delay metrics, wherein the respective priority levels can be associated with respective downlink data packets associated with the respective DRBs, and wherein the respective packet delay metrics can be associated with the respective downlink data packets and the respective priority levels. The communication manager component can determine the respective DRB delay metrics associated with the respective DRBs associated with the device as a function of the respective priority levels and the respective packet delay metrics, such as described herein. In some embodiments, the respective downlink data packets can be part of respective PDU sets of one or more respective data bursts associated with a service (e.g., an XR service) being utilized by the device.

At 704, scheduling of communication of the respective downlink data packets associated with the respective DRBs to the device can be determined based at least in part on the respective DRB delay metrics. The communication manager component (e.g., employing the scheduler component) can determine the scheduling of communication of the respective downlink data packets associated with the respective DRBs to the device based at least in part on the respective DRB delay metrics, such as described herein.

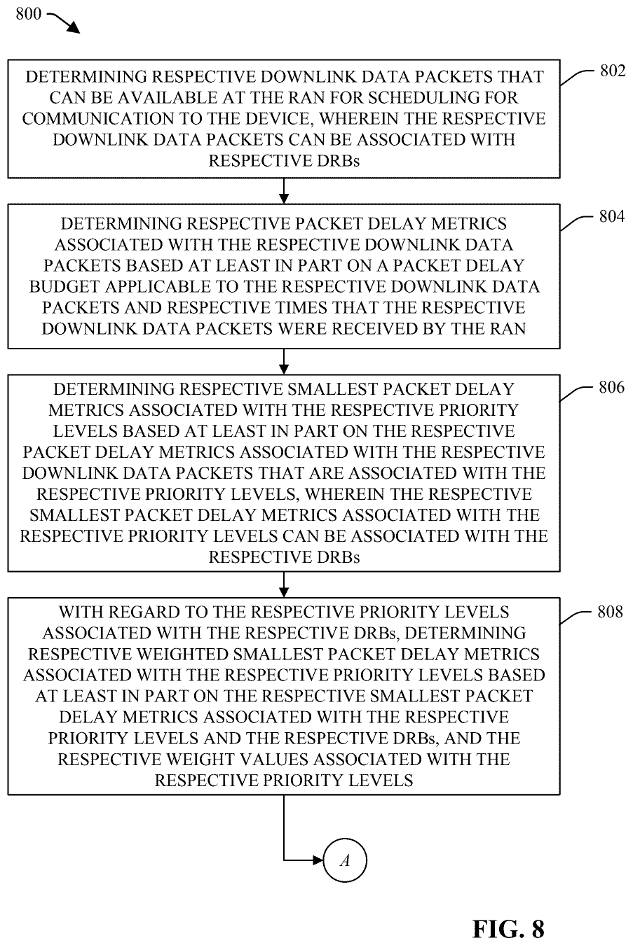

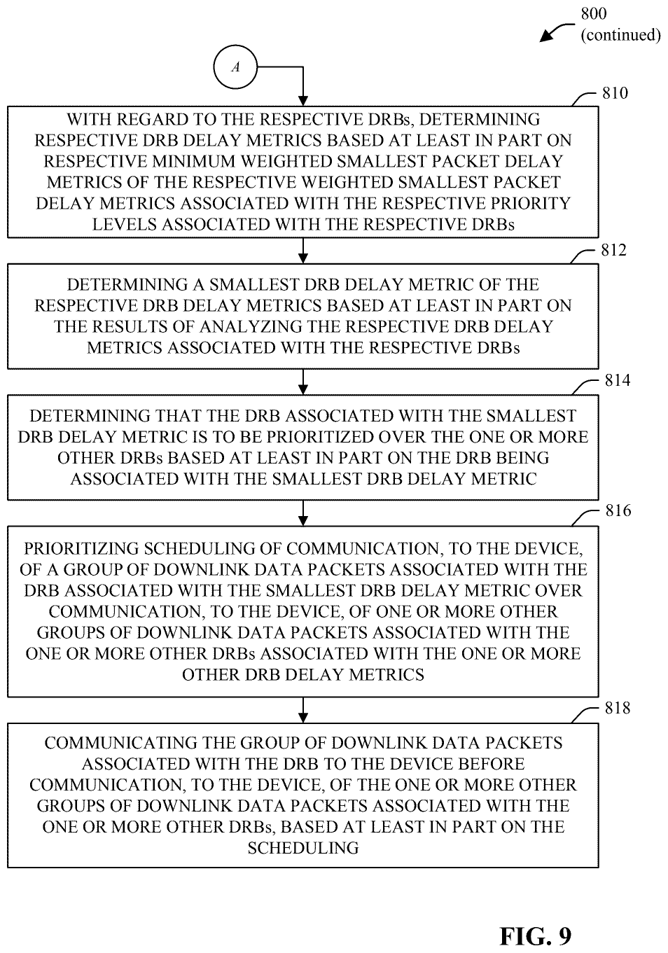

FIGS. 8 and 9 depict a flow chart of another example method 800 that can desirably (e.g., automatically, dynamically, suitably, reliably, efficiently, enhancedly, and/or optimally) enhance management of scheduling and communication of downlink data (e.g., PDU sets), in accordance with various aspects and embodiments of the disclosed subject matter. The method 800 can be employed by, for example, a system comprising the communication manager component, which can comprise or be associated with the processor component, the data store, and/or other components.

At 802, respective downlink data packets that can be available at the RAN for scheduling for communication to the device can be determined, wherein the respective downlink data packets can be associated with respective DRBs. The communication manager component can determine the respective downlink data packets that can be available at the RAN (e.g., RAN equipment of the RAN) for scheduling for communication to the device. In some embodiments, the respective downlink data packets can be part of respective PDU sets of one or more respective data bursts associated with a service (e.g., an XR service) being utilized by the device.

At 804, respective packet delay metrics associated with the respective downlink data packets can be determined based at least in part on a packet delay budget applicable to the respective downlink data packets and respective times that the respective downlink data packets were received by the RAN (e.g., the RAN equipment of the RAN). The communication manager component can determine the respective packet delay metrics associated with the respective downlink data packets based at least in part on (e.g., as a function of) the packet delay budget and the respective times that the respective downlink data packets were received by the RAN (e.g., for each PDU set associated with each DRB and a respective priority level, packet delay metric=packet delay budget−(current time−time when a first PDU of a PDU set associated with the DRB and associated with the respective priority level was received by the RAN from the UPF)).

At 806, respective smallest packet delay metrics associated with the respective priority levels can be determined based at least in part on the respective packet delay metrics associated with the respective downlink data packets that are associated with the respective priority levels, wherein the respective smallest packet delay metrics associated with the respective priority levels can be associated with the respective DRBs. The communication manager component can determine the respective smallest packet delay metrics associated with the respective priority levels and the respective DRBs based at least in part on the respective packet delay metrics associated with the respective downlink data packets that are associated with the respective priority levels.

At 808, with regard to the respective priority levels associated with the respective DRBs, respective weighted smallest packet delay metrics associated with the respective priority levels can be determined based at least in part on the respective smallest packet delay metrics associated with the respective priority levels and the respective DRBs, and the respective weight values associated with the respective priority levels. The communication manager component can determine the respective weighted smallest packet delay metrics associated with the respective priority levels based at least in part on (e.g., as a function of) the respective smallest packet delay metrics associated with the respective priority levels and the respective DRBs, and the respective weight values associated with the respective priority levels (e.g., with regard to each smallest packet delay metric associated with each priority level and each DRB, the weighted smallest packet delay metric=smallest packet delay metric associated with the priority level*the weight value associated with the priority level). At this point, the method 800 can proceed to reference point A, wherein the method 800 can continue from reference point A as depicted in FIG. 9.

At 810, with regard to the respective DRBs, respective DRB delay metrics can be determined based at least in part on respective minimum weighted smallest packet delay metrics of the respective weighted smallest packet delay metrics associated with the respective priority levels associated with the respective DRBs. For instance, the respective DRBs can comprise a first DRB and a second DRB. With regard to the first DRB, the communication manager component can determine (e.g., calculate) a first DRB delay metric associated with the first DRB based at least in part on (e.g., as a function of) a first minimum of one or more respective weighted smallest packet delay metrics associated with the one or more respective priority levels associated with the first DRB (e.g., if there are two priority levels associated with the first DRB, the first DRB delay metric=min (first weighted smallest packet delay metric associated with first priority level, second weighted smallest packet delay metric associated with second priority level). Similarly, with regard to the second DRB, the communication manager component can determine (e.g., calculate) a second DRB delay metric associated with the second DRB based at least in part on a second minimum of one or more respective weighted smallest packet delay metrics associated with the one or more respective priority levels associated with the second DRB.

At 812, a smallest DRB delay metric of the respective DRB delay metrics can be determined based at least in part on the results of analyzing the respective DRB delay metrics associated with the respective DRBs. The communication manager component can analyze the respective DRB delay metrics associated with the respective DRBs. Based at least in part on the results of analyzing the respective DRB delay metrics, the communication manager component can determine the smallest DRB delay metric (e.g., the first DRB delay metric) associated with a DRB (e.g., the first DRB) relative to one or more other DRB delay metrics associated with one or more other DRBs (e.g., the second DRB delay metric associated with the second DRB and/or another DRB delay metric(s) associated with another DRB(s), if any).

At 814, a determination can be made that the DRB associated with the smallest DRB delay metric is to be prioritized over the one or more other DRBs based at least in part on the DRB being associated with the smallest DRB delay metric. The communication manager component can determine that the DRB (e.g., the first DRB) associated with the smallest DRB delay metric (e.g., the first DRB delay metric) is to be prioritized over the one or more other DRBs (e.g., the second DRB) associated with the one or more other DRB delay metrics (e.g., the second DRB delay metric), based at least in part on the DRB being determined to be associated with the smallest DRB delay metric.

At 816, scheduling of communication, to the device, of a group of downlink data packets associated with the DRB associated with the smallest DRB delay metric can be prioritized over communication, to the device, of one or more other groups of downlink data packets associated with the one or more other DRBs associated with the one or more other DRB delay metrics. For instance, the communication manager component (e.g., employing the scheduler component) can prioritize scheduling of communication, to the device, of the group (e.g., a first group) of downlink data packets associated with the DRB (e.g., the first DRB) associated with the smallest DRB delay metric over communication, to the device, of one or more other groups (e.g., a second group) of downlink data packets associated with the one or more other DRBs (e.g., the second DRB) associated with the one or more other DRB delay metrics (e.g., the second DRB delay metric). In some embodiments, if there is a third DRB, and if the second DRB is determined to be associated with a second smallest DRB delay metric that is smaller than a third DRB delay metric associated with the third DRB, communication of the downlink data packets associated with the second DRB to the device can be prioritized over communication of the downlink data packets associated with the third DRB to the device.

At 818, the group of downlink data packets associated with the DRB can be communicated to the device before communication, to the device, of the one or more other groups of downlink data packets associated with the one or more other DRBs, based at least in part on the scheduling. For instance, based at least in part on (e.g., in accordance with) the scheduling, the communication manager component can control communication of the respective groups of downlink data packets to have the group of downlink data packets associated with the DRB communicated (e.g., by the RAN) to the device before communication (e.g., by the RAN) of the one or more other groups of downlink data packets associated with the one or more other DRBs to the device.

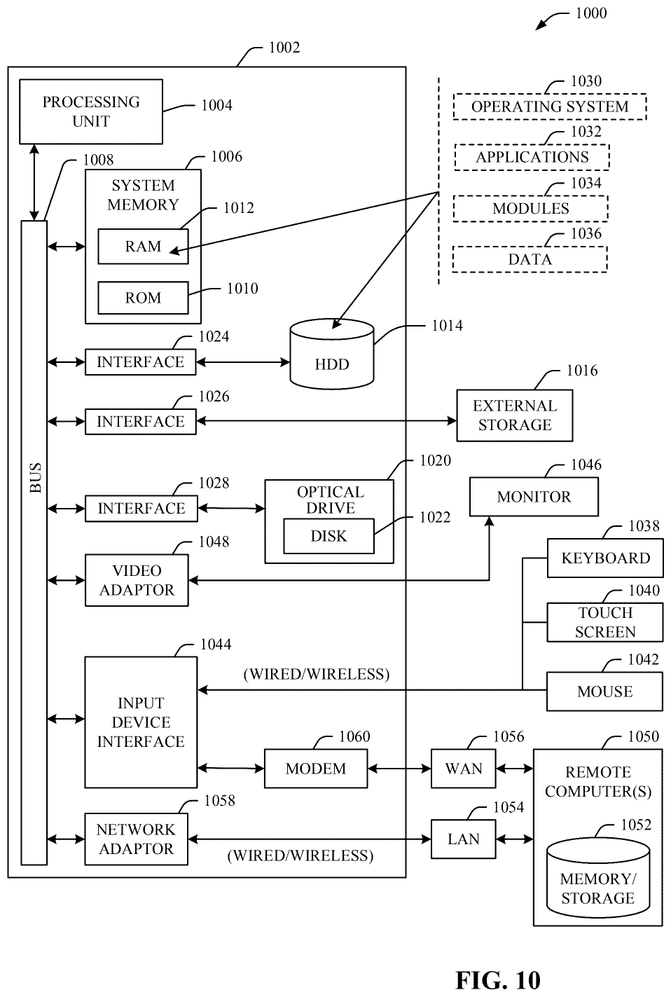

In order to provide additional context for various embodiments described herein, FIG. 10 and the following discussion are intended to provide a brief, general description of a suitable computing environment 1000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 also can be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056, e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, communication manager component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, respective data-radio-bearer delay metrics associated with respective data radio bearers associated with a device as a function of respective priority levels and respective packet delay metrics, wherein the respective priority levels are associated with respective downlink data packets associated with the respective data radio bearers, and wherein the respective packet delay metrics are associated with the respective downlink data packets and the respective priority levels; and
determining, by the system, a scheduling of communication of the respective downlink data packets associated with the respective data radio bearers to the device based on the respective data-radio-bearer delay metrics.

2. The method of claim 1, further comprising:
determining, by the system, that the respective downlink data packets are available at radio access network equipment for the scheduling for the communication to the device;
determining, by the system, the respective packet delay metrics associated with the respective downlink data packets as a function of a packet delay budget applicable to the respective downlink data packets and respective times that the respective downlink data packets were received by the radio access network equipment; and
determining, by the system, respective smallest packet delay metrics associated with the respective priority levels based on the respective packet delay metrics associated with the respective downlink data packets that are associated with the respective priority levels.

3. The method of claim 2, wherein the determining of the respective data-radio-bearer delay metrics comprises determining the respective data-radio-bearer delay metrics as a function of respective weight values associated with the respective priority levels, and the respective smallest packet delay metrics associated with the respective priority levels that are associated with the respective data radio bearers.

4. The method of claim 3, wherein the respective data radio bearers comprise a first data radio bearer and a second data radio bearer, wherein the respective data-radio-bearer delay metrics comprise a first data-radio-bearer delay metric associated with the first data radio bearer and a second data-radio-bearer delay metric associated with the second data radio bearer,
wherein the respective downlink data packets comprise a first downlink data packet and a second downlink data packet, wherein the respective priority levels comprise a first priority level associated with the first downlink data packet and a second priority level associated with the second downlink data packet, wherein the respective smallest packet delay metrics comprise a first smallest packet delay metric associated with the first priority level and a second smallest packet delay metric associated with the second priority level, wherein the respective weight values comprise a first weight value associated with the first priority level and a second weight value associated with the second priority level, wherein the first data radio bearer is associated with the first smallest packet delay metric and the second smallest packet delay metric, and
wherein the method further comprises:
determining, by the system, a first value as a function of the first smallest packet delay metric and the first weight value; and
determining, by the system, a second value as a function of the second smallest packet delay metric and the second weight value, wherein the determining of the respective data-radio-bearer delay metrics comprises determining the first data-radio-bearer delay metric as a function of a minimum value of the first value and the second value.

5. The method of claim 1, wherein the respective data radio bearers comprise a first data radio bearer and a second data radio bearer, wherein the respective data-radio-bearer delay metrics comprise a first data-radio-bearer delay metric associated with the first data radio bearer and a second data-radio-bearer delay metric associated with the second data radio bearer, wherein the respective downlink data packets comprise a first downlink data packet associated with the first data radio bearer and a second downlink data packet associated with the second data radio bearer, and wherein the method further comprises:
determining, by the system, that the first data radio bearer has priority over the second data radio bearer with regard to the scheduling based on determining that the first data-radio-bearer delay metric is smaller than the second data-radio-bearer delay metric,
wherein the determining of the scheduling comprises determining that scheduling of communication of the first downlink data packet to the device is to be prioritized over communication of the second downlink data packet to the device based on the determining that the first data radio bearer has priority over the second data radio bearer with regard to the scheduling.

6. The method of claim 1, further comprising:
communicating, by the system, the respective downlink data packets associated with the respective data radio bearers to the device based on the scheduling.

7. The method of claim 1, further comprising:
determining, by the system, a threshold weight step size based on a maximum threshold weight value, a minimum threshold weight value, and a number of priority levels of a group of priority levels comprising the respective priority levels; and
determining, by the system, respective weight values associated with the respective priority levels based on the minimum threshold weight value, the threshold weight step size, and respective numerical values associated with the number of priority levels,
wherein the determining of the respective data-radio-bearer delay metrics comprises determining the respective data-radio-bearer delay metrics as a function of the respective weight values associated with the respective priority levels, and respective smallest packet delay metrics associated with the respective priority levels that are associated with the respective data radio bearers.

8. The method of claim 1, further comprising:
performing, by the system, an artificial intelligence-based analysis on information relating to communication sessions associated with devices comprising the device, the respective downlink data packets, previous downlink data packets, the respective data radio bearers, previous data radio bearers, the respective packet delay metrics, previous packet delay metrics, the respective data-radio-bearer delay metrics, previous data-radio-bearer delay metrics, a group of priority levels comprising the respective priority levels, weight values associated with the group of priority levels, a maximum threshold weight value, a minimum threshold weight value, weight threshold step sizes, prioritization of data radio bearers, or scheduling of downlink data packets; and
based on results of the artificial intelligence-based analysis:
predicting, by the system, a packet delay metric associated with a downlink data packet of the respective downlink data packets;
predicting, by the system, a data-radio-bearer delay metric associated with a data radio bearer of the respective data radio bearers;
predicting, by the system, a mapping of priority levels to the weight values;
adapting, by the system, the mapping of the priority levels to the weight values;
predicting, by the system, an adjustment of the maximum threshold weight value, the minimum threshold weight value, or a weight threshold step size;
adapting, by the system, respective weight values associated with the respective priority levels based on the adjustment of the maximum threshold weight value, the minimum threshold weight value, or the weight threshold step size; or
from the respective data radio bearers, predicting, by the system, a first data radio bearer to prioritize over a second data radio bearer with regard to the scheduling.

9. The method of claim 1, wherein the respective downlink data packets are associated with respective protocol data unit sets, and wherein the respective protocol data unit sets are associated with one or more respective data bursts.

10. The method of claim 8, wherein the respective protocol data unit sets relate to an extended reality service or a service that involves communication of the one or more respective data bursts comprising the respective protocol data unit sets.

11. A system, comprising:
at least one memory that stores computer executable components; and
at least one processor that executes computer executable components stored in the at least one memory, wherein the computer executable components comprise:
a communication manager that determines respective data-radio-bearer delay values associated with respective data radio bearers associated with a user equipment based on respective importance values and respective packet delay values, wherein the respective importance values are associated with respective downlink data packets associated with the respective data radio bearers, and wherein the respective packet delay values are associated with the respective downlink data packets and the respective importance values; and
a scheduler that determines a scheduling of communication of the respective downlink data packets associated with the respective data radio bearers to the user equipment based on the respective data-radio-bearer delay values.

12. The system of claim 11, wherein the communication manager determines the respective downlink data packets that are available at radio access network equipment for the scheduling for the communication to the user equipment, and determines the respective packet delay values associated with the respective downlink data packets based on a packet delay budget value applicable to the respective downlink data packets and respective times that the respective downlink data packets were received by the radio access network equipment, and
wherein the communication manager determines respective smallest packet delay values associated with the respective importance values based on the respective packet delay values associated with the respective downlink data packets that are associated with the respective importance values.

13. The system of claim 12, wherein the communication manager determines the respective data-radio-bearer delay values based on respective weight values associated with the respective importance values, and based on the respective smallest packet delay values associated with the respective importance values that are associated with the respective data radio bearers.

14. The system of claim 13, wherein the respective data radio bearers comprise a first data radio bearer and a second data radio bearer, wherein the respective data-radio-bearer delay values comprise a first data-radio-bearer delay value associated with the first data radio bearer and a second data-radio-bearer delay value associated with the second data radio bearer,
wherein the respective downlink data packets comprise a first downlink data packet and a second downlink data packet, wherein the respective importance values comprise a first importance value associated with the first downlink data packet and a second importance value associated with the second downlink data packet, wherein the respective smallest packet delay values comprise a first smallest packet delay value associated with the first importance value and a second smallest packet delay value associated with the second importance value, wherein the respective weight values comprise a first weight value associated with the first importance value and a second weight value associated with the second importance value, wherein the first data radio bearer is associated with the first smallest packet delay value and the second smallest packet delay value,
wherein the communication manager determines a first value based on the first smallest packet delay value and the first weight value, and determines a second value based on the second smallest packet delay value and the second weight value, and wherein the communication manager determines the first data-radio-bearer delay value based on a minimum value of the first value and the second value.

15. The system of claim 11, wherein the respective data radio bearers comprise a first data radio bearer and a second data radio bearer, wherein the respective data-radio-bearer delay values comprise a first data-radio-bearer delay value associated with the first data radio bearer and a second data-radio-bearer delay value associated with the second data radio bearer, wherein the respective downlink data packets comprise a first downlink data packet associated with the first data radio bearer and a second downlink data packet associated with the second data radio bearer, and
wherein the communication manager determines that the first data radio bearer is to be prioritized over the second data radio bearer with regard to the scheduling based on determining that the first data-radio-bearer delay value is smaller than the second data-radio-bearer delay value, and
wherein the communication manager determines that scheduling of communication of the first downlink data packet to the user equipment is to be prioritized over communication of the second downlink data packet to the user equipment based on the determination that the first data radio bearer is to be prioritized over the second data radio bearer with regard to the scheduling.

16. The system of claim 11, wherein the communication manager determines a threshold weight step size based on a maximum threshold weight value, a minimum threshold weight value, and a number of importance values of a group of importance values comprising the respective importance values,
wherein the communication manager determines respective weight values associated with the respective importance values based on the minimum threshold weight value, the threshold weight step size, and respective numerical values associated with the number of importance values, and
wherein the communication manager determines the respective data-radio-bearer delay values based on the respective weight values associated with the respective importance values, and based on respective smallest packet delay values associated with the respective importance values that are associated with the respective data radio bearers.

17. The system of claim 11, wherein the respective downlink data packets are associated with respective protocol data unit sets, and wherein the respective protocol data unit sets are associated with one or more respective data bursts.

18. The system of claim 17, wherein the respective protocol data unit sets relate to an extended reality service or a service that involves communication of the one or more respective data bursts comprising the respective protocol data unit sets.

19. A non-transitory machine-readable medium, comprising executable instructions that, when executed by at least one processor, facilitate performance of operations, comprising:
determining respective data-radio-bearer delay values associated with respective data radio bearers associated with a user equipment based on respective priority levels and respective packet delay values, wherein the respective priority levels are associated with respective downlink data packets associated with the respective data radio bearers, and wherein the respective packet delay values are associated with the respective downlink data packets and the respective priority levels; and
scheduling transmission of the respective downlink data packets associated with the respective data radio bearers to the user equipment based on the respective data-radio-bearer delay values.

20. The non-transitory machine-readable medium of claim 19, wherein the operations further comprise:
determining that the respective downlink data packets are available at radio access network equipment for the scheduling of the transmission to the user equipment;
determining the respective packet delay values associated with the respective downlink data packets based on a packet delay budget value applicable to the respective downlink data packets and respective times that the respective downlink data packets were received by the radio access network equipment; and
determining respective smallest packet delay values associated with the respective priority levels based on the respective packet delay values associated with the respective downlink data packets that are associated with the respective priority levels,
wherein the determining of the respective data-radio-bearer delay values comprises determining the respective data-radio-bearer delay values based on respective weight values associated with the respective priority levels, and based on the respective smallest packet delay values associated with the respective priority levels that are associated with the respective data radio bearers.
